(19) United States
(12) Patent Application Publication
(10) Pub. No.: US 2024/0078768 A1
(43) Pub. Date: Mar. 7, 2024

(54) SYSTEM AND METHOD FOR LEARNING AND RECOGNIZING OBJECT-CENTERED ROUTINES

(71) Applicant: Meta Platforms Technologies, LLC, Menlo Park, CA (US)

(72) Inventors: Karthik Mahadevan, Toronto (CA); Lucas Furukawa Gadani, Toronto (CA); Tanya Renee Jonker, Seattle, WA (US); Ting Zhang, Santa Clara, CA (US); Frances Cin-Yee Lai, York (CA); Anna Camilla Martinez, Seattle, WA (US); Ruta Parimal Desai, Mountlake Terrace, WA (US); Yan Xu, Kirkland, WA (US)

(21) Appl. No.: 18/459,935

(22) Filed: Sep. 1, 2023

Related U.S. Application Data
(60) Provisional application No. 63/374,653, filed on Sep. 6, 2022.

(51) Int. Cl. G06T 19/00; G02B 27/01; G06F 3/01; G06V 40/20

(52) U.S. Cl. CPC G06T 19/006; G02B 27/0172; G06F 3/013; G06F 3/017; G06V 40/20

(57) ABSTRACT

Features described herein generally relate to learning and recognizing object-centered routines. Particularly, object-centered routines can be learned and recognized by collecting data corresponding to a user. The data can include information representing interactions by the user with respect to objects in an environment. The routine can be learned by presenting a visual graph to the user. The user can define nodes associating an interaction with an object, specify a relationship between nodes, and arrange the nodes into segments. The visual graph can be stored, and a routine can be recognized based on the visual graph.

### CROSS-REFERENCE TO RELATED APPLICATIONS

The present application is based on and claims benefit of U.S. Provisional Application No. 63/374,653 having a filing date of Sep. 6, 2022, which is incorporated by reference herein in its entirety and for all purposes.

### FIELD

The present disclosure generally relates to artificial intelligence (AI). Particularly, the present disclosure relates to a system and method for learning and recognizing object-centered routines.

### BACKGROUND

A virtual assistant is an artificial intelligence (AI) enabled software agent that can perform tasks or services including: answer questions, provide information, play media, and provide an intuitive interface for connected devices (e.g., smart home devices) for an individual based on voice or text utterances (e.g., commands or questions). Conventional virtual assistants process the words a user speaks or types and converts them into digital data that the software can analyze. The software uses a speech and/or text recognition-algorithm to find the most likely answer, solution to a problem, information, or command for a given task. As the number of utterances increase, the software learns over time what users want when they supply various utterances. This helps improve the reliability and speed of responses and services. In addition to their self-learning ability, their customizable features and scalability have led virtual assistants to gain popularity across various domain spaces including website chat, computing devices (e.g., smart phones and vehicles), and standalone passive listening devices (e.g., smart speakers).

Even though virtual assistants have proven to be a powerful tool, these domain spaces have also proven to be an inappropriate venue for such a tool. The virtual assistant will continue to be an integral part in these domain spaces but will always likely be viewed as a complementary feature or limited use case, but not a crucial must have feature. Recently, developers have been looking for a better suited domain space for deploying virtual assistants. That domain space is extended reality. Extended reality is a form of reality that has been adjusted in some manner before presentation to a user and generally includes virtual reality (VR), augmented reality (AR), mixed reality (MR), hybrid reality, some combination thereof, and/or derivatives thereof.

Extended reality content may include generated virtual content or generated virtual content that is combined with physical content (e.g., physical or real-world objects). The extended reality content may include digital images, animations, video, audio, haptic feedback, and/or some combination thereof, and any of which may be presented in a single channel or in multiple channels (e.g., stereo video that produces a three-dimensional effect to the viewer). Extended reality may be associated with applications, products, accessories, services, and the like that can be used to create extended reality content and/or used in (e.g., perform activities in) an extended reality. An extended reality system that provides such content may be implemented on various platforms, including a head-mounted display (HMD) connected to a host computer system, a standalone HMD, a mobile device or computing system, and/or any other hardware platform capable of providing extended reality content to one or more viewers.

However, extended reality headsets and devices are limited in the way users interact with applications. Some provide hand controllers, but controllers betray the point of freeing the user's hands and limit the use of extended reality headsets. Others have developed sophisticated hand gestures for interacting with the components of extended reality applications. Hand gestures are a good medium, but they have their limits. For example, given the limited field of view that extended reality headsets have, hand gestures require users to keep their arms extended so that they enter the active area of the headset's sensors. This can cause fatigue and again limit the use of the headset. This is why virtual assistants have become important as a new interface for extended reality devices such as headsets. Virtual assistants can easily blend in with all the other features that the extended reality devices provide to their users. Virtual assistants can help users accomplish tasks with their extended reality devices that previously required controller input or hand gestures on or in view of the extended reality devices. Users can use virtual assistants to open and close applications, activate features, or interact with virtual objects. When combined with other technologies such as eye tracking, virtual assistants can become even more useful. For instance, users can query for information about the object they are staring at, or ask the virtual assistant to revolve, move, or manipulate a virtual object without using gestures.

### BRIEF SUMMARY

Embodiments described herein pertain to a system and method for learning and recognizing object-centered routines.

In some implementations, an extended reality system is provided that includes a head-mounted device that has a display for displaying content to a user and one or more sensors that capture input including images of a visual field of the user wearing the head-mounted device; one or more processors; and one or more memories that are accessible to the one or more processors and that store instructions that are executable by the one or more processors and, when executed by the one or more processors, cause the one or more processors to learn and recognize object-centered routines.

In some implementations, object-centered routines can be learned by collecting, at least using the one or more sensors, first data corresponding to a routine performed by the user, the first data including information representing a plurality of interactions by the user with respect to a plurality of objects in a real-world environment, a virtual environment, or a combination thereof; and learning the routine from the collected first data.

In some implementations, object-centered routines can be recognized by collecting, at least using the one or more sensors, second data including information representing a plurality of interactions by the user with respect to a plurality of objects in a real-world environment, a virtual environment, or a combination thereof; recognizing a routine from the collected second data, the recognized routine corresponding the learned routine; and triggering one or more automations in response to recognizing the routine.

In some implementations, learning the routine from the collected first data includes: presenting a visual graph to the user; defining a plurality of nodes in the visual graph based on input received from the user, wherein at least one node of the plurality of nodes associates at least one interaction of the plurality of interactions with at least one object of the plurality of objects; specifying a relationship between a first node and a second node of the plurality of nodes in the visual graph; arranging the plurality of nodes in the visual graph into a plurality of segments based on the relationship between the first node and the second node of the plurality of nodes; and storing the visual graph in a data structure for the routine.

In some implementations, the plurality of interactions include an interaction in which the user touches an object of the plurality of objects, an interaction in which an object of the plurality of objects appears in a view of the user, an interaction in which an object of the plurality of objects disappears from a view of the user, an interaction in which an object of the plurality of objects is present in a view of the user when the routine is performed by the user, or any combination thereof.

In some implementations, the input received from the user includes at least one of a natural language statement made by the user, a gesture made by the user, and a gaze of the user.

In some implementations, at least one other node of the plurality of nodes associates the at least one object of the plurality of objects with at least one other object of the plurality of objects.

In some implementations, the relationship between the first node and the second node of the plurality of nodes is a sequential relationship representing that an object corresponding to the first node occurs in a sequence before an object corresponding to the second node.

In some implementations, the plurality of segments includes a start segment that includes a node of the plurality of nodes representing a beginning of the routine and an end segment that includes a node of the plurality of nodes representing a ending of the routine.

In some implementations, a method includes collecting, at least using one or more sensors of a head-mounted device, first data corresponding to a routine performed by a user, the first data comprising information representing a plurality of interactions by the user with respect to a plurality of objects in a real-world environment, a virtual environment, or a combination thereof; and learning the routine from the collected first data.

In some implementations, learning the routine from the collected first data includes presenting a visual graph to the user; defining a plurality of nodes in the visual graph based on input received from the user, wherein at least one node of the plurality of nodes associates at least one interaction of the plurality of interactions with at least one object of the plurality of objects; specifying a relationship between a first node and a second node of the plurality of nodes in the visual graph; arranging the plurality of nodes in the visual graph into a plurality of segments based on the relationship between the first node and the second node of the plurality of nodes; and storing the visual graph in a data structure for the routine.

In some implementations, the plurality of interactions include an interaction in which the user touches an object of the plurality of objects, an interaction in which an object of the plurality of objects appears in a view of the user, an interaction in which an object of the plurality of objects disappears from a view of the user, an interaction in which an object of the plurality of objects is present in a view of the user when the routine is performed by the user, or any combination thereof.

In some implementations, the input received from the user includes a natural language statement made by the user, a gesture made by the user, a gaze of the user, or any combination thereof.

In some implementations, at least one other node of the plurality of nodes associates the at least one object of the plurality of objects with at least one other object of the plurality of objects.

In some implementations, the relationship between the first node and the second node of the plurality of nodes is a sequential relationship representing that an object corresponding to the first node occurs in a sequence before an object corresponding to the second node.

In some implementations, the plurality of segments comprising a start segment that includes a node of the plurality of nodes representing a beginning of the routine and an end segment that includes a node of the plurality of nodes representing an ending of the routine.

In some implementations, the method also includes collecting, at least using the one or more sensors, second data comprising information representing a plurality of interactions by the user with respect to a plurality of objects in a real-world environment, a virtual environment, or a combination thereof; recognizing a routine from the collected second data, the recognized routine corresponding the learned routine; and triggering one or more automations in response to recognizing the routine.

Some implementations of the present disclosure also include one or more non-transitory computer-readable media storing computer-readable instructions that, when executed by one or more processing systems, cause the one or more processing systems to perform part or all of the one or more operations and/or the one or more methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a simplified block diagram of a network environment in accordance with various embodiments.

FIG. 2A is an illustration depicting an example extended reality system that presents and controls user interface elements within an extended reality environment in accordance with various embodiments.

FIG. 2B is an illustration depicting user interface elements in accordance with various embodiments.

FIG. 3A is an illustration of an augmented reality system in accordance with various embodiments.

FIG. 3B is an illustration of a virtual reality system in accordance with various embodiments.

FIG. 4A is an illustration of haptic devices in accordance with various embodiments.

FIG. 4B is an illustration of an exemplary virtual reality environment in accordance with various embodiments.

FIG. 4C is an illustration of an exemplary augmented reality environment in accordance with various embodiments.

FIG. 5 is an illustration of an extended reality system for learning and recognizing object-centered routines in accordance with various embodiments.

FIG. 6 is an illustration of an exemplary scenario of an object-centered routine in accordance with various embodiments.

FIG. 7A is an illustration of an exemplary user interface for learning object-centered routines in accordance with various embodiments.

FIG. 7B is an illustration of another exemplary user interface for learning object-centered routines in accordance with various embodiments.

FIG. 7C is an illustration of another exemplary user interface for learning object-centered routines in accordance with various embodiments.

FIG. 7D is an illustration of another exemplary user interface for learning object-centered routines in accordance with various embodiments.

FIG. 8 is a flowchart of a process for learning object-centered routines in accordance with various embodiments.

FIG. 9 is a flowchart of a process for recognizing object-centered routines in accordance with various embodiments.

FIG. 10 is an illustration of a portable electronic device in accordance with various embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### INTRODUCTION

Extended reality systems are becoming increasingly ubiquitous with applications in many fields, such as computer gaming, health and safety, industrial, and education. As a few examples, extended reality systems are being incorporated into mobile devices, gaming consoles, personal computers, movie theaters, and theme parks. Typical extended reality systems include one or more devices for rendering and displaying content to users. As one example, an extended reality system may incorporate a head-mounted device (HMD) worn by a user and configured to output extended reality content to the user. The extended reality content may be generated in a wholly or partially simulated environment (extended reality environment) that people sense and/or interact with via an electronic system. The simulated environment may be a virtual reality (VR) environment, which is designed to be based entirely on computer-generated sensory inputs (e.g., virtual content) for one or more user senses, or a mixed reality (MR) environment, which is designed to incorporate sensory inputs (e.g., a view of the physical surroundings) from the physical environment, or a representation thereof, in addition to including computer-generated sensory inputs (e.g., virtual content). Examples of MR include augmented reality (AR) and augmented virtuality (AV). An AR environment is a simulated environment in which one or more virtual objects are superimposed over a physical environment, or a representation thereof, or a simulated environment in which a representation of a physical environment is transformed by computer-generated sensory information. An AV environment is a simulated environment in which a virtual or computer-generated environment incorporates one or more sensory inputs from the physical environment. In any instance, during operation in a VR, MR, AR, or AV environment, the user typically interacts with and within the extended reality system to interact with extended reality content.

In many activities undertaken via VR, MR, AR, or AV, users freely roam through the extended reality environment and are provided with content that contains information that may be important and/or relevant to a user's experience within the extended reality environment. For example, an extended reality system may assist a user with performance of a task in a physical environment by providing them with content such as information about their environment and instructions for performing the task. Users often perform routines in the extended reality environment. For example, a user may perform a daily routine in the extended reality environment that involves the user performing a sequence of actions and interacting with one or more objects in the extended reality environment. However, these extended reality systems do not provide a means to recognize a user's routines, provide content relevant to the user's routines, and/or trigger automations in response to the user performing their routines.

In order to overcome this and other challenges, techniques are disclosed herein for learning and recognizing object-centered routines. In exemplary embodiments, an extended reality system is provided that can learn and recognize an object-centered routine and trigger an automation in response to recognizing that an object-centered routine is being performed. For example, an object-centered routine can be learned by collecting, at least using the one or more sensors, first data corresponding to a routine performed by the user and including information representing interactions by the user with respect to objects in a real-world environment, a virtual environment, or a combination thereof and learning the routine from the collected first data. A routine can be learned from the collected first data by presenting a visual graph to the user, defining nodes in the visual graph based on input received from the user where at least one node associates at least one interaction of the interactions with at least one object of the objects, specifying a relationship between a first node and a second node of the nodes in the visual graph, arranging the nodes in the visual graph into segments based on the relationship between the first node and the second node of the nodes, and storing the visual graph in a data structure for the routine. An object-centered routine can be recognized by collecting, at least using the one or more sensors, second data that includes information representing interactions by the user with respect to objects in a real-world environment, a virtual environment, or a combination thereof and recognizing a routine corresponding to the learned routine from the collected second data based on the visual graph of the learned routine. One or more automations can be triggered in response to recognizing the routine.

### Extended Reality System Overview

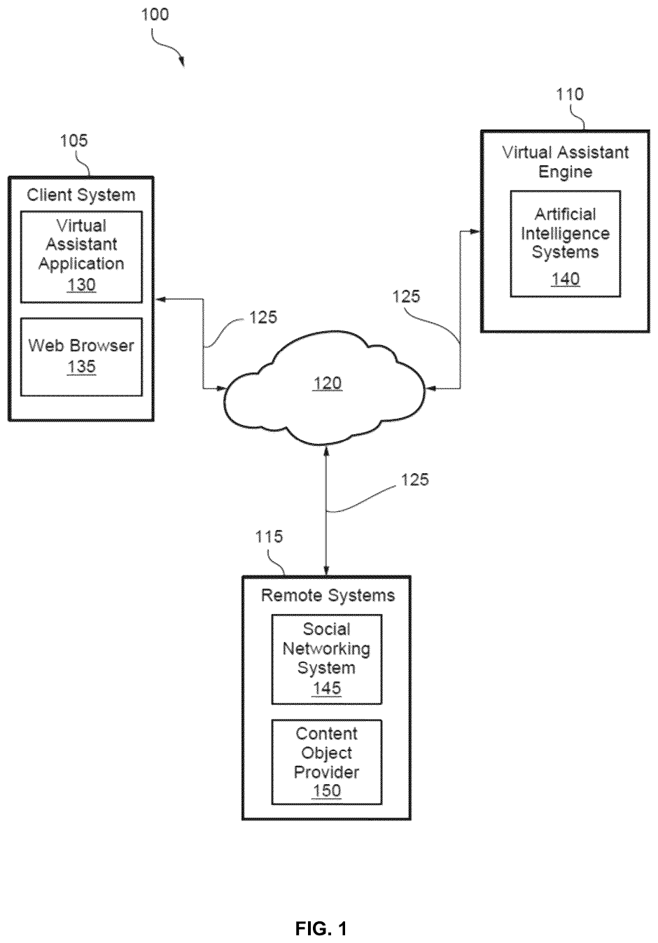

FIG. 1 illustrates an example network environment 100 associated with an extended reality system in accordance with aspects of the present disclosure. Network environment 100 includes a client system 105, a virtual assistant engine 110, and remote systems 115 connected to each other by a network 120. Although FIG. 1 illustrates a particular arrangement of the client system 105, the virtual assistant engine 110, the remote systems 115, and the network 120, this disclosure contemplates any suitable arrangement. As an example, and not by way of limitation, two or more of the client system 105, the virtual assistant engine 110, and the remote systems 115 may be connected to each other directly, bypassing the network 120. As another example, two or more of the client system 105, the virtual assistant engine 110, and the remote systems 115 may be physically or logically co-located with each other in whole or in part. Moreover, although FIG. 1 illustrates a particular number of the client system 105, the virtual assistant engine 110, the remote systems 115, and the network 120, this disclosure contemplates any suitable number of client systems 105, virtual assistant engine 110, remote systems 115, and networks 120. As an example, and not by way of limitation, network environment 100 may include multiple client systems, such as client system 105; virtual assistant engines, such as virtual assistant engine 110; remote systems, such as remote systems 115; and networks, such as network 120.

This disclosure contemplates that network 120 may be any suitable network. As an example, and not by way of limitation, one or more portions of a network 120 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Additionally, the network 120 may include one or more networks.

Links 125 may connect the client system 105, the virtual assistant engine 110, and the remote systems 115 to the network 120, to another communication network (not shown), or to each other. This disclosure contemplates links 125 may include any number and type of suitable links. In particular embodiments, one or more of the links 125 include one or more wireline links (e.g., Digital Subscriber Line or Data Over Cable Service Interface Specification), wireless links (e.g., Wi-Fi or Worldwide Interoperability for Microwave Access), or optical links (e.g., Synchronous Optical Network or Synchronous Digital Hierarchy). In particular embodiments, each link of the links 125 includes an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 125, or a combination of two or more such links. Links 125 need not necessarily be the same throughout a network environment 100. For example, some links of the links 125 may differ in one or more respects from some other links of the links 125.

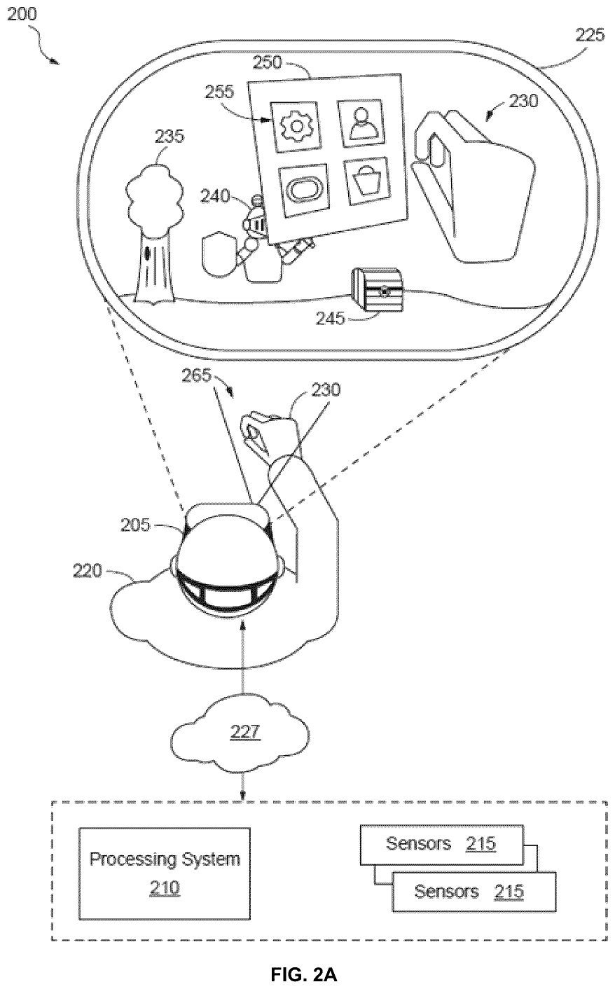

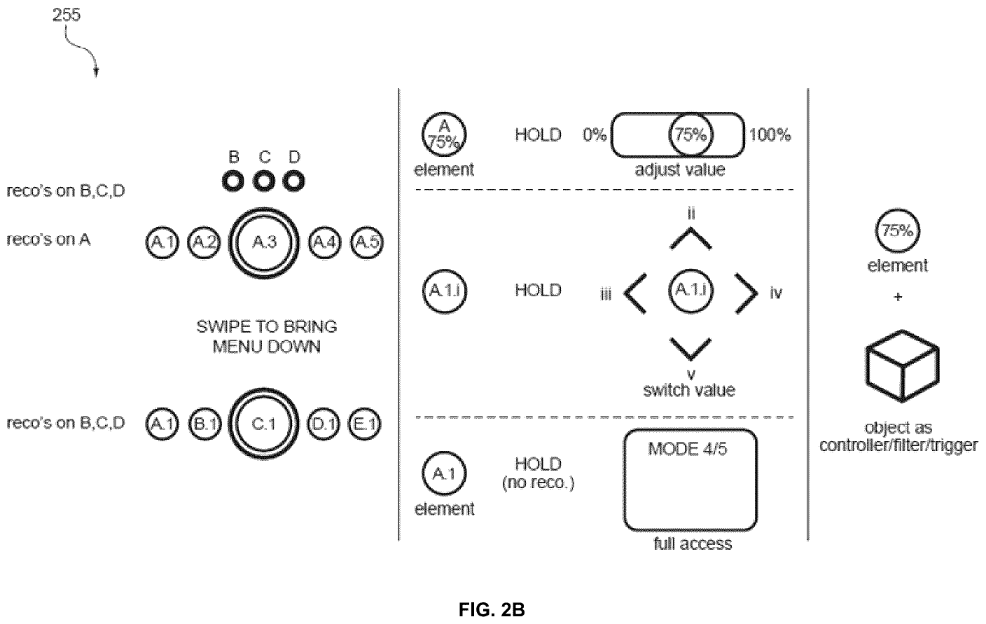

In various embodiments, the client system 105 is an electronic device including hardware, software, or embedded logic components or a combination of two or more such components and capable of carrying out the appropriate extended reality functionalities in accordance with techniques of the disclosure. As an example, and not by way of limitation, the client system 105 may include a desktop computer, notebook or laptop computer, netbook, a tablet computer, e-book reader, global positioning system (GPS) device, camera, personal digital assistant, handheld electronic device, cellular telephone, smartphone, a VR, MR, AR, or AV headset or HMD, any suitable electronic device capable of displaying extended reality content, or any suitable combination thereof. In particular embodiments, the client system 105 is a VR/AR HMD, such as described in detail with respect to FIG. 2. This disclosure contemplates any suitable client system 105 that is configured to generate and output extended reality content to the user. The client system 105 may enable its user to communicate with other users at other client systems.

In various embodiments, the client system 105 includes a virtual assistant application 130. The virtual assistant application 130 instantiates at least a portion of a virtual assistant, which can provide information or services to a user based on user input, contextual awareness (such as clues from the physical environment or clues from user behavior), and the capability to access information from a variety of online sources (such as weather conditions, traffic information, news, stock prices, user schedules, and/or retail prices). As used herein, when an action is “based on” something, this means the action is based at least in part on at least a part of the something. The user input may include text (e.g., online chat), especially in an instant messaging application or other applications, voice, eye-tracking, user motion, such as gestures or running, or a combination of them. The virtual assistant may perform concierge-type services (e.g., making dinner reservations, purchasing event tickets, making travel arrangements, and the like), provide information (e.g., reminders, information concerning an object in an environment, information concerning a task or interaction, answers to questions, training regarding a task or activity, and the like), provide goal assisted services (e.g., generating and implementing a recipe to cook a meal in a certain amount of time, implementing tasks to clean in a most efficient manner, generating and executing a construction plan including allocation of tasks to two or more workers, and the like), or combinations thereof. The virtual assistant may also perform management or data-handling tasks based on online information and events without user initiation or interaction. Examples of those tasks that may be performed by the virtual assistant may include schedule management (e.g., sending an alert to a dinner date to which a user is running late due to traffic conditions, updating schedules for both parties, and changing the restaurant reservation time). The virtual assistant may be enabled in an extended reality environment by a combination of the client system 105, the virtual assistant engine 110, application programming interfaces (APIs), and the proliferation of applications on user devices, such as the remote systems 115.

A user at the client system 105 may use the virtual assistant application 130 to interact with the virtual assistant engine 110. In some instances, the virtual assistant application 130 is a stand-alone application or integrated into another application, such as a social-networking application or another suitable application (e.g., an artificial simulation application). In some instances, the virtual assistant application 130 is integrated into the client system 105 (e.g., part of the operating system of the client system 105), an assistant hardware device, or any other suitable hardware devices. In some instances, the virtual assistant application 130 may be accessed via a web browser 135. In some instances, the virtual assistant application 130 passively listens to and watches interactions of the user in the real-world, and processes what it hears and sees (e.g., explicit input, such as audio commands or interface commands, contextual awareness derived from audio or physical actions of the user, objects in the real-world, environmental triggers such as weather or time, and the like) in order to interact with the user in an intuitive manner.

In particular embodiments, the virtual assistant application 130 receives or obtains input from a user, the physical environment, a virtual reality environment, or a combination thereof via different modalities. As an example, and not by way of limitation, the modalities may include audio, text, image, video, motion, graphical or virtual user interfaces, orientation, and/or sensors. The virtual assistant application 130 communicates the input to the virtual assistant engine 110. Based on the input, the virtual assistant engine 110 analyzes the input and generates responses (e.g., text or audio responses, device commands, such as a signal to turn on a television, virtual content such as a virtual object, or the like) as output. The virtual assistant engine 110 may send the generated responses to the virtual assistant application 130, the client system 105, the remote systems 115, or a combination thereof. The virtual assistant application 130 may present the response to the user at the client system 105 (e.g., rendering virtual content overlaid on a real-world object within the display). The presented responses may be based on different modalities, such as audio, text, image, and video. As an example, and not by way of limitation, context concerning activity of a user in the physical world may be analyzed and determined to initiate an interaction for completing an immediate task or goal, which may include the virtual assistant application 130 retrieving traffic information (e.g., via remote systems 115). The virtual assistant application 130 may communicate the request for traffic information to virtual assistant engine 110. The virtual assistant engine 110 may accordingly contact a third-party system and retrieve traffic information as a result of the request and send the traffic information back to the virtual assistant application 110. The virtual assistant application 110 may then present the traffic information to the user as text (e.g., as virtual content overlaid on the physical environment, such as real-world object) or audio (e.g., spoken to the user in natural language through a speaker associated with the client system 105).

In some embodiments, the client system 105 may collect or otherwise be associated with data. In some embodiments, the data may be collected from or pertain to any suitable computing system or application (e.g., a social-networking system, other client systems, a third-party system, a messaging application, a photo-sharing application, a biometric data acquisition application, an artificial-reality application, a virtual assistant application).

In some embodiments, privacy settings (or “access settings”) may be provided for the data. The privacy settings may be stored in any suitable manner (e.g., stored in an index on an authorization server). A privacy setting for the data may specify how the data or particular information associated with the data can be accessed, stored, or otherwise used (e.g., viewed, shared, modified, copied, executed, surfaced, or identified) within an application (e.g., an extended reality application). When the privacy settings for the data allow a particular user or other entity to access that the data, the data may be described as being “visible” with respect to that user or other entity. For example, a user of an extended reality application or virtual assistant application may specify privacy settings for a user profile page that identifies a set of users that may access the extended reality application or virtual assistant application information on the user profile page and excludes other users from accessing that information. As another example, an extended reality application or virtual assistant application may store privacy policies/guidelines. The privacy policies/guidelines may specify what information of users may be accessible by which entities and/or by which processes (e.g., internal research, advertising algorithms, machine-learning algorithms) to ensure only certain information of the user may be accessed by certain entities or processes.

In some embodiments, privacy settings for the data may specify a “blocked list” of users or other entities that should not be allowed to access certain information associated with the data. In some cases, the blocked list may include third-party entities. The blocked list may specify one or more users or entities for which the data is not visible.

In some embodiments, privacy settings associated with the data may specify any suitable granularity of permitted access or denial of access. As an example, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. In some embodiments, different pieces of the data of the same type associated with a user may have different privacy settings. In addition, one or more default privacy settings may be set for each piece of data of a particular data type.

In various embodiments, the virtual assistant engine 110 assists users to retrieve information from different sources, request services from different service providers, assist users to learn or complete goals and tasks using different sources and/or service providers, and combinations thereof. In some instances, the virtual assistant engine 110 receives input data from the virtual assistant application 130 and determines one or more interactions based on the input data that could be executed to request information, services, and/or complete a goal or task of the user. The interactions are actions that could be presented to a user for execution in an extended reality environment. In some instances, the interactions are influenced by other actions associated with the user. The interactions are aligned with goals or tasks associated with the user. Goals may include things that a user wants to occur or desires (e.g., as a meal, a piece of furniture, a repaired automobile, a house, a garden, a clean apartment, and the like). Tasks may include things that need to be done or activities that should be carried out in order to accomplish a goal or carry out an aim (e.g., cooking a meal using one or more recipes, building a piece of furniture, repairing a vehicle, building a house, planting a garden, cleaning one or more rooms of an apartment, and the like). Each goal and task may be associated with a workflow of actions or sub-tasks for performing the task and achieving the goal. For example, for preparing a salad, a workflow of actions or sub-tasks may includes ingredients needed, any equipment needed for the steps (e.g., a knife, a stove top, a pan, a salad spinner), sub-tasks for preparing ingredients (e.g., chopping onions, cleaning lettuce, cooking chicken), and sub-tasks for combining ingredients into subcomponents (e.g., cooking chicken with olive oil and Italian seasonings).

The virtual assistant engine 110 may use AI systems 140 (e.g., rule-based systems and/or machine-learning based systems) to analyze the input based on a user's profile and other relevant information. The result of the analysis may include different interactions associated with a task or goal of the user. The virtual assistant engine 110 may then retrieve information, request services, and/or generate instructions, recommendations, or virtual content associated with one or more of the different interactions for completing tasks or goals. In some instances, the virtual assistant engine 110 interacts with remote systems 115, such as a social-networking system 145 when retrieving information, requesting service, and/or generating instructions or recommendations for the user. The virtual assistant engine 110 may generate virtual content for the user using various techniques, such as natural language generating, virtual object rendering, and the like. The virtual content may include, for example, the retrieved information; the status of the requested services; a virtual object, such as a glimmer overlaid on a physical object such as an appliance, light, or piece of exercise equipment; a demonstration for a task, and the like. In particular embodiments, the virtual assistant engine 110 enables the user to interact with it regarding the information, services, or goals using a graphical or virtual interface, a stateful and multi-turn conversation using dialog-management techniques, and/or a stateful and multi-action interaction using task-management techniques.

In various embodiments, remote systems 115 may include one or more types of servers, one or more data stores, one or more interfaces, including but not limited to APIs, one or more web services, one or more content sources, one or more networks, or any other suitable components, e.g., that servers may communicate with. A remote system 115 may be operated by a same entity or a different entity from an entity operating the virtual assistant engine 110. In particular embodiments, however, the virtual assistant engine 110 and third-party systems may operate in conjunction with each other to provide virtual content to users of the client system 105. For example, a social-networking system 145 may provide a platform, or backbone, which other systems, such as third-party systems, may use to provide social-networking services and functionality to users across the Internet, and the virtual assistant engine 110 may access these systems to provide virtual content on the client system 105.

In particular embodiments, the social-networking system 145 may be a network-addressable computing system that can host an online social network. The social-networking system 145 may generate, store, receive, and send social-networking data, such as user-profile data, concept-profile data, social-graph information, or other suitable data related to the online social network. The social-networking system 145 may be accessed by the other components of network environment 100 either directly or via a network 120. As an example, and not by way of limitation, the client system 105 may access the social-networking system 145 using a web browser 135, or a native application associated with the social-networking system 145 (e.g., a mobile social-networking application, a messaging application, another suitable application, or any combination thereof) either directly or via a network 120. The social-networking system 145 may provide users with the ability to take actions on various types of items or objects, supported by the social-networking system 145. As an example, and not by way of limitation, the items and objects may include groups or social networks to which users of the social-networking system 145 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 145 or by an external system of the remote systems 115, which is separate from the social-networking system 145 and coupled to the social-networking system via the network 120.

Remote systems 115 may include a content object provider 150. A content object provider 150 includes one or more sources of virtual content objects, which may be communicated to the client system 105. As an example, and not by way of limitation, virtual content objects may include information regarding things or activities of interest to the user, such as movie show times, movie reviews, restaurant reviews, restaurant menus, product information and reviews, instructions on how to perform various tasks, exercise regimens, cooking recipes, or other suitable information. As another example and not by way of limitation, content objects may include incentive content objects, such as coupons, discount tickets, gift certificates, or other suitable incentive objects. As another example and not by way of limitation, content objects may include virtual objects, such as virtual interfaces, two-dimensional (2D) or three-dimensional (3D) graphics, media content, or other suitable virtual objects.

FIG. 2A illustrates an example client system 200 (e.g., client system 105 described with respect to FIG. 1) in accordance with aspects of the present disclosure. Client system 200 includes an extended reality system 205 (e.g., an HMD), a processing system 210, and one or more sensors 215. As shown, extended reality system 205 is typically worn by user 220 and includes an electronic display (e.g., a transparent, translucent, or solid display), optional controllers, and optical assembly for presenting extended reality content 225 to the user 220. The one or more sensors 215 may include motion sensors (e.g., accelerometers) for tracking motion of the extended reality system 205 and may include one or more image capturing devices (e.g., cameras, line scanners) for capturing images and other information of the surrounding physical environment. In this example, processing system 210 is shown as a single computing device, such as a gaming console, workstation, a desktop computer, or a laptop. In other examples, processing system 210 may be distributed across a plurality of computing devices, such as a distributed computing network, a data center, or a cloud computing system. In other examples, processing system 210 may be integrated with the HMD. Extended reality system 205, processing system 210, and the one or more sensors 215 are communicatively coupled via a network 227, which may be a wired or wireless network, such as Wi-Fi, a mesh network, or a short-range wireless communication medium, such as Bluetooth wireless technology, or a combination thereof. Although extended reality system 205 is shown in this example as in communication with, e.g., tethered to or in wireless communication with, the processing system 210, in some implementations, extended reality system 205 operates as a stand-alone, mobile extended reality system.

In general, client system 200 uses information captured from a real-world, physical environment to render extended reality content 225 for display to the user 220. In the example of FIG. 2A, the user 220 views the extended reality content 225 constructed and rendered by an extended reality application executing on processing system 210 and/or extended reality system 205. In some examples, the extended reality content 225 viewed through the extended reality system 205 includes a mixture of real-world imagery (e.g., the user's hand 230 and physical objects 235) and virtual imagery (e.g., virtual content, such as information or objects 240, 245 and virtual user interface 250) to produce mixed reality and/or augmented reality. In some examples, virtual information or objects 240, 245 may be mapped (e.g., pinned, locked, placed) to a particular position within extended reality content 225. For example, a position for virtual information or objects 240, 245 may be fixed, as relative to one of walls of a residence or surface of the earth, for instance. A position for virtual information or objects 240, 245 may be variable, as relative to a physical object 235 or the user 220, for instance. In some examples, the particular position of virtual information or objects 240, 245 within the extended reality content 225 is associated with a position within the real world, physical environment (e.g., on a surface of a physical object 235).

In the example shown in FIG. 2A, virtual information or objects 240, 245 are mapped at a position relative to a physical object 235. As should be understood, the virtual imagery (e.g., virtual content, such as information or objects 240, 245 and virtual user interface 250) does not exist in the real-world, physical environment. Virtual user interface 250 may be fixed, as relative to the user 220, the user's hand 230, physical objects 235, or other virtual content, such as virtual information or objects 240, 245, for instance. As a result, client system 200 renders, at a user interface position that is locked relative to a position of the user 220, the user's hand 230, physical objects 235, or other virtual content in the extended reality environment, virtual user interface 250 for display at extended reality system 205 as part of extended reality content 225. As used herein, a virtual element ‘locked’ to a position of virtual content or a physical object is rendered at a position relative to the position of the virtual content or physical object so as to appear to be part of or otherwise tied in the extended reality environment to the virtual content or physical object.

In some implementations, the client system 200 generates and renders virtual content (e.g., GIFs, photos, applications, live-streams, videos, text, a web-browser, drawings, animations, representations of data files, or any other visible media) on a virtual surface. A virtual surface may be associated with a planar or other real-world surface (e.g., the virtual surface corresponds to and is locked to a physical surface, such as a wall, table, or ceiling). In the example shown in FIG. 2A, the virtual surface is associated with the sky and ground of the physical environment. In other examples, a virtual surface can be associated with a portion of a surface (e.g., a portion of the wall). In some examples, only the virtual content items contained within a virtual surface are rendered. In other examples, the virtual surface is generated and rendered (e.g., as a virtual plane or as a border corresponding to the virtual surface). In some examples, a virtual surface can be rendered as floating in a virtual or real-world physical environment (e.g., not associated with a particular real-world surface). The client system 200 may render one or more virtual content items in response to a determination that at least a portion of the location of virtual content items is in a field of view of the user 220. For example, client system 200 may render virtual user interface 250 only if a given physical object (e.g., a lamp) is within the field of view of the user 220.

During operation, the extended reality application constructs extended reality content 225 for display to user 220 by tracking and computing interaction information (e.g., tasks for completion) for a frame of reference, typically a viewing perspective of extended reality system 205. Using extended reality system 205 as a frame of reference and based on a current field of view as determined by a current estimated interaction of extended reality system 205, the extended reality application renders extended reality content 225 which, in some examples, may be overlaid, at least in part, upon the real-world, physical environment of the user 220. During this process, the extended reality application uses sensed data received from extended reality system 205 and sensors 215, such as movement information, contextual awareness, and/or user commands, and, in some examples, data from any external sensors, such as third-party information or device, to capture information within the real world, physical environment, such as motion by user 220 and/or feature tracking information with respect to user 220. Based on the sensed data, the extended reality application determines interaction information to be presented for the frame of reference of extended reality system 205 and, in accordance with the current context of the user 220, renders the extended reality content 225.

Client system 200 may trigger generation and rendering of virtual content based on a current field of view of user 220, as may be determined by real-time gaze 265 tracking of the user, or other conditions. More specifically, image capture devices of the sensors 215 capture image data representative of objects in the real-world, physical environment that are within a field of view of image capture devices. During operation, the client system 200 performs object recognition within images captured by the image capturing devices of extended reality system 205 to identify objects in the physical environment, such as the user 220, the user's hand 230, and/or physical objects 235. Further, the client system 200 tracks the position, orientation, and configuration of the objects in the physical environment over a sliding window of time. Field of view typically corresponds with the viewing perspective of the extended reality system 205. In some examples, the extended reality application presents extended reality content 225 that includes mixed reality and/or augmented reality.

As illustrated in FIG. 2A, the extended reality application may render virtual content, such as virtual information or objects 240, 245 on a transparent display such that the virtual content is overlaid on real-world objects, such as the portions of the user 220, the user's hand 230, or physical objects 235, that are within a field of view of the user 220. In other examples, the extended reality application may render images of real-world objects, such as the portions of the user 220, the user's hand 230, or physical objects 235, that are within a field of view along with virtual objects, such as virtual information or objects 240, 245 within extended reality content 225. In other examples, the extended reality application may render virtual representations of the portions of the user 220, the user's hand 230, and physical objects 235 that are within a field of view (e.g., render real-world objects as virtual objects) within extended reality content 225. In either example, user 220 is able to view the portions of the user 220, the user's hand 230, physical objects 235 and/or any other real-world objects or virtual content that are within a field of view within extended reality content 225. In other examples, the extended reality application may not render representations of the user 220 and the user's hand 230; the extended reality application may instead only render the physical objects 235 and/or virtual information or objects 240, 245.

In various embodiments, the client system 200 renders to extended reality system 205 extended reality content 225 in which virtual user interface 250 is locked relative to a position of the user 220, the user's hand 230, physical objects 235, or other virtual content in the extended reality environment. That is, the client system 205 may render a virtual user interface 250 having one or more virtual user interface elements at a position and orientation that are based on and correspond to the position and orientation of the user 220, the user's hand 230, physical objects 235, or other virtual content in the extended reality environment. For example, if a physical object is positioned in a vertical position on a table, the client system 205 may render the virtual user interface 250 at a location corresponding to the position and orientation of the physical object in the extended reality environment. Alternatively, if the user's hand 230 is within the field of view, the client system 200 may render the virtual user interface at a location corresponding to the position and orientation of the user's hand 230 in the extended reality environment. Alternatively, if other virtual content is within the field of view, the client system 200 may render the virtual user interface at a location corresponding to a general predetermined position of the field of view (e.g., a bottom of the field of view) in the extended reality environment. Alternatively, if other virtual content is within the field of view, the client system 200 may render the virtual user interface at a location corresponding to the position and orientation of the other virtual content in the extended reality environment. In this way, the virtual user interface 250 being rendered in the virtual environment may track the user 220, the user's hand 230, physical objects 235, or other virtual content such that the user interface appears, to the user, to be associated with the user 220, the user's hand 230, physical objects 235, or other virtual content in the extended reality environment.

As shown in FIGS. 2A and 2B, virtual user interface 250 includes one or more virtual user interface elements. Virtual user interface elements may include, for instance, a virtual drawing interface; a selectable menu (e.g., a drop-down menu); virtual buttons, such as button element 255; a virtual slider or scroll bar; a directional pad; a keyboard; other user-selectable user interface elements including glyphs, display elements, content, user interface controls, and so forth. The particular virtual user interface elements for virtual user interface 250 may be context-driven based on the current extended reality applications engaged by the user 220 or real-world actions/tasks being performed by the user 220. When a user performs a user interface gesture in the extended reality environment at a location that corresponds to one of the virtual user interface elements of virtual user interface 250, the client system 200 detects the gesture relative to the virtual user interface elements and performs an action associated with the gesture and the virtual user interface elements. For example, the user 220 may press their finger at a button element 255 location on the virtual user interface 250. The button element 255 and/or virtual user interface 250 location may or may not be overlaid on the user 220, the user's hand 230, physical objects 235, or other virtual content, e.g., correspond to a position in the physical environment, such as on a light switch or controller at which the client system 200 renders the virtual user interface button. In this example, the client system 200 detects this virtual button press gesture and performs an action corresponding to the detected press of a virtual user interface button (e.g., turns the light on). The client system 205 may also, for instance, animate a press of the virtual user interface button along with the button press gesture.

The client system 200 may detect user interface gestures and other gestures using an inside-out or outside-in tracking system of image capture devices and or external cameras. The client system 200 may alternatively, or in addition, detect user interface gestures and other gestures using a presence-sensitive surface. That is, a presence-sensitive interface of the extended reality system 205 and/or controller may receive user inputs that make up a user interface gesture. The extended reality system 205 and/or controller may provide haptic feedback to touch-based user interaction by having a physical surface with which the user can interact (e.g., touch, drag a finger across, grab, and so forth). In addition, peripheral extended reality system 205 and/or controller may output other indications of user interaction using an output device. For example, in response to a detected press of a virtual user interface button, extended reality system 205 and/or controller may output a vibration or “click” noise, or extended reality system 205 and/or controller may generate and output content to a display. In some examples, the user 220 may press and drag their finger along physical locations on the extended reality system 205 and/or controller corresponding to positions in the virtual environment at which the client system 205 renders virtual user interface elements of virtual user interface 250. In this example, the client system 205 detects this gesture and performs an action according to the detected press and drag of virtual user interface elements, such as by moving a slider bar in the virtual environment. In this way, client system 200 simulates movement of virtual content using virtual user interface elements and gestures.

Various embodiments disclosed herein may include or be implemented in conjunction with various types of extended reality systems. Extended reality content generated by the extended reality systems may include completely computer-generated content or computer-generated content combined with captured (e.g., real-world) content. The extended reality content may include video, audio, haptic feedback, or some combination thereof, any of which may be presented in a single channel or in multiple channels (e.g., stereo video that produces a 3D effect to the viewer). Additionally, in some embodiments, extended reality may also be associated with applications, products, accessories, services, or some combination thereof, that are used to, for example, create content in an extended reality and/or are otherwise used in (e.g., to perform activities in) an extended reality.

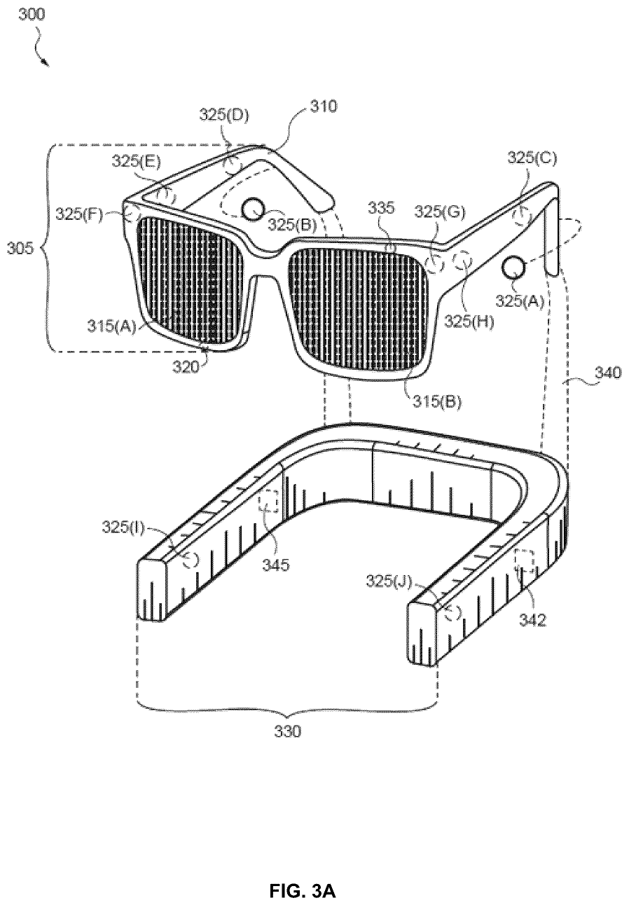

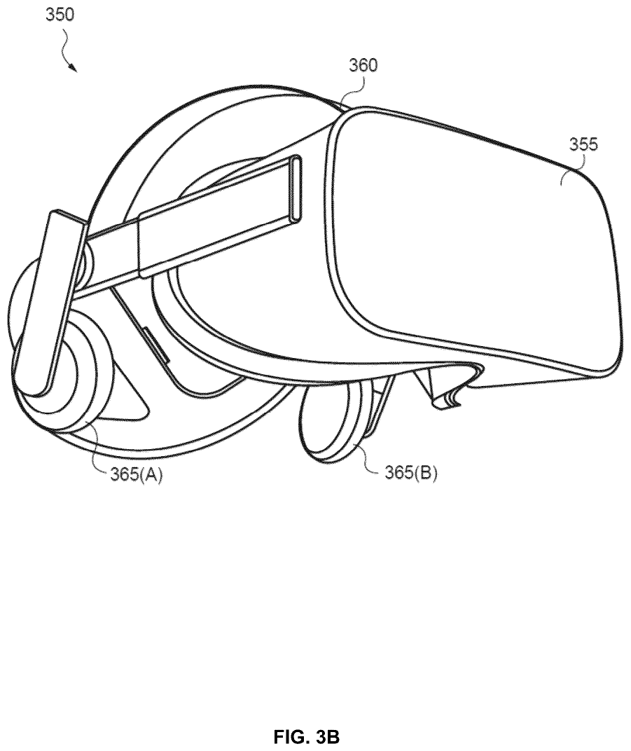

The extended reality systems may be implemented in a variety of different form factors and configurations. Some extended reality systems may be designed to work without near-eye displays (NEDs). Other extended reality systems may include an NED that also provides visibility into the real world (e.g., augmented reality system 300 in FIG. 3A) or that visually immerses a user in an extended reality (e.g., virtual reality system 350 in FIG. 3B). While some extended reality devices may be self-contained systems, other extended reality devices may communicate and/or coordinate with external devices to provide an extended reality experience to a user. Examples of such external devices include handheld controllers, mobile devices, desktop computers, devices worn by a user, devices worn by one or more other users, and/or any other suitable external system.

As shown in FIG. 3A, augmented reality system 300 may include an eyewear device 305 with a frame 310 configured to hold a left display device 315(A) and a right display device 315(B) in front of a user's eyes. Display devices 315(A) and 315(B) may act together or independently to present an image or series of images to a user. While augmented reality system 300 includes two displays, embodiments of this disclosure may be implemented in augmented reality systems with a single NED or more than two NEDs.

In some embodiments, augmented reality system 300 may include one or more sensors, such as sensor 320. Sensor 320 may generate measurement signals in response to motion of augmented reality system 300 and may be located on substantially any portion of frame 310. Sensor 320 may represent one or more of a variety of different sensing mechanisms, such as a position sensor, an inertial measurement unit (IMU), a depth camera assembly, a structured light emitter and/or detector, or any combination thereof. In some embodiments, augmented reality system 300 may or may not include sensor 320 or may include more than one sensor. In embodiments in which sensor 320 includes an IMU, the IMU may generate calibration data based on measurement signals from sensor 320. Examples of sensor 320 may include, without limitation, accelerometers, gyroscopes, magnetometers, other suitable types of sensors that detect motion, sensors used for error correction of the IMU, or some combination thereof.

In some examples, augmented reality system 300 may also include a microphone array with a plurality of acoustic transducers 325(A)-325(J), referred to collectively as acoustic transducers 325. Acoustic transducers 325 may represent transducers that detect air pressure variations induced by sound waves. Each acoustic transducer 325 may be configured to detect sound and convert the detected sound into an electronic format (e.g., an analog or digital format). The microphone array in FIG. 3A may include, for example, ten acoustic transducers: 325(A) and 325(B), which may be designed to be placed inside a corresponding ear of the user, acoustic transducers 325(C), 325(D), 325(E), 325(F), 325(G), and 325(H), which may be positioned at various locations on frame 310, and/or acoustic transducers 325(I) and 325(J), which may be positioned on a corresponding neckband 330.

In some embodiments, one or more of acoustic transducers 325(A)—(J) may be used as output transducers (e.g., speakers). For example, acoustic transducers 325(A) and/or 325(B) may be earbuds or any other suitable type of headphone or speaker. The configuration of acoustic transducers 325 of the microphone array may vary. While augmented reality system 300 is shown in FIG. 3A as having ten acoustic transducers, the number of acoustic transducers 325 may be greater or less than ten. In some embodiments, using higher numbers of acoustic transducers 325 may increase the amount of audio information collected and/or the sensitivity and accuracy of the audio information. In contrast, using a lower number of acoustic transducers 325 may decrease the computing power required by an associated controller 335 to process the collected audio information. In addition, the position of each acoustic transducer 325 of the microphone array may vary. For example, the position of an acoustic transducer 325 may include a defined position on the user, a defined coordinate on frame 310, an orientation associated with each acoustic transducer 325, or some combination thereof.

Acoustic transducers 325(A) and 325(B) may be positioned on different parts of the user's ear, such as behind the pinna, behind the tragus, and/or within the auricle or fossa. Alternatively, or additionally, there may be additional acoustic transducers 325 on or surrounding the ear in addition to acoustic transducers 325 inside the ear canal. Having an acoustic transducer 325 positioned next to an ear canal of a user may enable the microphone array to collect information on how sounds arrive at the ear canal. By positioning at least two of acoustic transducers 325 on either side of a user's head (e.g., as binaural microphones), augmented reality system 300 may simulate binaural hearing and capture a 3D stereo sound field around a user's head. In some embodiments, acoustic transducers 325(A) and 325(B) may be connected to augmented reality system 300 via a wired connection 340, and in other embodiments acoustic transducers 325(A) and 325(B) may be connected to augmented reality system 300 via a wireless connection (e.g., a Bluetooth connection). In still other embodiments, acoustic transducers 325(A) and 325(B) may not be used at all in conjunction with augmented reality system 300.

Acoustic transducers 325 on frame 310 may be positioned in a variety of different ways, including along the length of the temples, across the bridge, above or below display devices 315(A) and 315(B), or some combination thereof. Acoustic transducers 325 may also be oriented such that the microphone array is able to detect sounds in a wide range of directions surrounding the user wearing the augmented reality system 300. In some embodiments, an optimization process may be performed during manufacturing of augmented reality system 300 to determine relative positioning of each acoustic transducer 325 in the microphone array.

In some examples, augmented reality system 300 may include or be connected to an external device (e.g., a paired device), such as neckband 330. Neckband 330 generally represents any type or form of paired device. Thus, the following discussion of neckband 330 may also apply to various other paired devices, such as charging cases, smart watches, smart phones, wrist bands, other wearable devices, hand-held controllers, tablet computers, laptop computers, and/or other external computing devices.

As shown, neckband 330 may be coupled to eyewear device 305 via one or more connectors. The connectors may be wired or wireless and may include electrical and/or non-electrical (e.g., structural) components. In some cases, eyewear device 305 and neckband 330 may operate independently without any wired or wireless connection between them. While FIG. 3A illustrates the components of eyewear device 305 and neckband 330 in example locations on eyewear device 305 and neckband 330, the components may be located elsewhere and/or distributed differently on eyewear device 305 and/or neckband 330. In some embodiments, the components of eyewear device 305 and neckband 330 may be located on one or more additional peripheral devices paired with eyewear device 305, neckband 330, or some combination thereof.

Pairing external devices, such as neckband 330, with augmented reality eyewear devices may enable the eyewear devices to achieve the form factor of a pair of glasses while still providing sufficient battery and computation power for expanded capabilities. Some or all of the battery power, computational resources, and/or additional features of augmented reality system 300 may be provided by a paired device or shared between a paired device and an eyewear device, thus reducing the weight, heat profile, and form factor of the eyewear device overall while still retaining desired functionality. For example, neckband 330 may allow components that would otherwise be included on an eyewear device to be included in neckband 330 since users may tolerate a heavier weight load on their shoulders than they would tolerate on their heads. Neckband 330 may also have a larger surface area over which to diffuse and disperse heat to the ambient environment. Thus, neckband 330 may allow for greater battery and computation capacity than might otherwise have been possible on a stand-alone eyewear device. Since weight carried in neckband 330 may be less invasive to a user than weight carried in eyewear device 305, a user may tolerate wearing a lighter eyewear device and carrying or wearing the paired device for greater lengths of time than a user would tolerate wearing a heavy standalone eyewear device, thereby enabling users to incorporate extended reality environments more fully into their day-to-day activities.

Neckband 330 may be communicatively coupled with eyewear device 305 and/or to other devices. These other devices may provide certain functions (e.g., tracking, localizing, depth mapping, processing, storage) to augmented reality system 300. In the embodiment of FIG. 3A, neckband 330 may include two acoustic transducers (e.g., 325(I) and 325(J)) that are part of the microphone array (or potentially form their own microphone subarray). Neckband 330 may also include a controller 342 and a power source 345.

Acoustic transducers 325(I) and 325(J) of neckband 330 may be configured to detect sound and convert the detected sound into an electronic format (analog or digital). In the embodiment of FIG. 3A, acoustic transducers 325(I) and 325(J) may be positioned on neckband 330, thereby increasing the distance between the neckband acoustic transducers 325(I) and 325(J) and other acoustic transducers 325 positioned on eyewear device 305. In some cases, increasing the distance between acoustic transducers 325 of the microphone array may improve the accuracy of beamforming performed via the microphone array. For example, if a sound is detected by acoustic transducers 325(C) and 325(D) and the distance between acoustic transducers 325(C) and 325(D) is greater than, e.g., the distance between acoustic transducers 325(D) and 325(E), the determined source location of the detected sound may be more accurate than if the sound had been detected by acoustic transducers 325(D) and 325(E).

Controller 342 of neckband 330 may process information generated by the sensors on neckband 330 and/or augmented reality system 300. For example, controller 342 may process information from the microphone array that describes sounds detected by the microphone array. For each detected sound, controller 342 may perform a direction-of-arrival (DOA) estimation to estimate a direction from which the detected sound arrived at the microphone array. As the microphone array detects sounds, controller 342 may populate an audio data set with the information. In embodiments in which augmented reality system 300 includes an inertial measurement unit, controller 342 may compute all inertial and spatial calculations from the IMU located on eyewear device 305. A connector may convey information between augmented reality system 300 and neckband 330 and between augmented reality system 300 and controller 342. The information may be in the form of optical data, electrical data, wireless data, or any other transmittable data form. Moving the processing of information generated by augmented reality system 300 to neckband 330 may reduce weight and heat in eyewear device 305, making it more comfortable to the user.

Power source 345 in neckband 330 may provide power to eyewear device 305 and/or to neckband 330. Power source 345 may include, without limitation, lithium-ion batteries, lithium-polymer batteries, primary lithium batteries, alkaline batteries, or any other form of power storage. In some cases, power source 345 may be a wired power source. Including power source 345 on neckband 330 instead of on eyewear device 305 may help better distribute the weight and heat generated by power source 345.

As noted, some extended reality systems may, instead of blending an extended reality with actual reality, substantially replace one or more of a user's sensory perceptions of the real world with a virtual experience. One example of this type of system is a head-worn display system, such as virtual reality system 350 in FIG. 3B, that mostly or completely covers a user's field of view. Virtual reality system 350 may include a front rigid body 355 and a band 360 shaped to fit around a user's head. Virtual reality system 350 may also include output audio transducers 365(A) and 365(B). Furthermore, while not shown in FIG. 3B, front rigid body 355 may include one or more electronic elements, including one or more electronic displays, one or more inertial measurement units (IMUs), one or more tracking emitters or detectors, and/or any other suitable device or system for creating an extended reality experience.

Extended reality systems may include a variety of types of visual feedback mechanisms. For example, display devices in augmented reality system 300 and/or virtual reality system 350 may include one or more liquid crystal displays (LCDs), light emitting diode (LED) displays, organic LED (OLED) displays, digital light project (DLP) micro-displays, liquid crystal on silicon (LCoS) micro-displays, and/or any other suitable type of display screen. These extended reality systems may include a single display screen for both eyes or may provide a display screen for each eye, which may allow for additional flexibility for varifocal adjustments or for correcting a user's refractive error. Some of these extended reality systems may also include optical subsystems having one or more lenses (e.g., conventional concave or convex lenses, Fresnel lenses, adjustable liquid lenses) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (e.g., a single lens configuration that directly collimates light but results in so-called pincushion distortion) and/or a pupil-forming architecture (e.g., a multi-lens configuration that produces so-called barrel distortion to nullify pincushion distortion).

In addition to or instead of using display screens, some of the extended reality systems described herein may include one or more projection systems. For example, display devices in augmented reality system 300 and/or virtual reality system 350 may include micro-LED projectors that project light (using, e.g., a waveguide) into display devices, such as clear combiner lenses that allow ambient light to pass through. The display devices may refract the projected light toward a user's pupil and may enable a user to simultaneously view both extended reality content and the real world. The display devices may accomplish this using any of a variety of different optical components, including waveguide components (e.g., holographic, planar, diffractive, polarized, and/or reflective waveguide elements), light-manipulation surfaces and elements (e.g., diffractive, reflective, and refractive elements and gratings), and/or coupling elements. Extended reality systems may also be configured with any other suitable type or form of image projection system, such as retinal projectors used in virtual retina displays.

The extended reality systems described herein may also include various types of computer vision components and subsystems. For example, augmented reality system 300 and/or virtual reality system 350 may include one or more optical sensors, such as 2D or 3D cameras, structured light transmitters and detectors, time-of-flight depth sensors, single-beam or sweeping laser rangefinders, 3D LiDAR sensors, and/or any other suitable type or form of optical sensor. An extended reality system may process data from one or more of these sensors to identify a location of a user, to map the real world, to provide a user with context about real-world surroundings, and/or to perform a variety of other functions.

The extended reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the extended reality systems described herein may also include tactile (e.g., haptic) feedback systems, which may be incorporated into headwear, gloves, body suits, handheld controllers, environmental devices (e.g., chairs, floormats), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other extended reality devices, within other extended reality devices, and/or in conjunction with other extended reality devices.

By providing haptic sensations, audible content, and/or visual content, extended reality systems may create an entire virtual experience or enhance a user's real-world experience in a variety of contexts and environments. For instance, extended reality systems may assist or extend a user's perception, memory, or cognition within a particular environment. Some systems may enhance a user's interactions with other people in the real world or may enable more immersive interactions with other people in a virtual world. Extended reality systems may also be used for educational purposes (e.g., for teaching or training in schools, hospitals, government organizations, military organizations, business enterprises), entertainment purposes (e.g., for playing video games, listening to music, watching video content), and/or for accessibility purposes (e.g., as hearing aids, visual aids). The embodiments disclosed herein may enable or enhance a user's extended reality experience in one or more of these contexts and environments and/or in other contexts and environments.

As noted, extended reality systems 300 and 350 may be used with a variety of other types of devices to provide a more compelling extended reality experience. These devices may be haptic interfaces with transducers that provide haptic feedback and/or that collect haptic information about a user's interaction with an environment. The extended reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

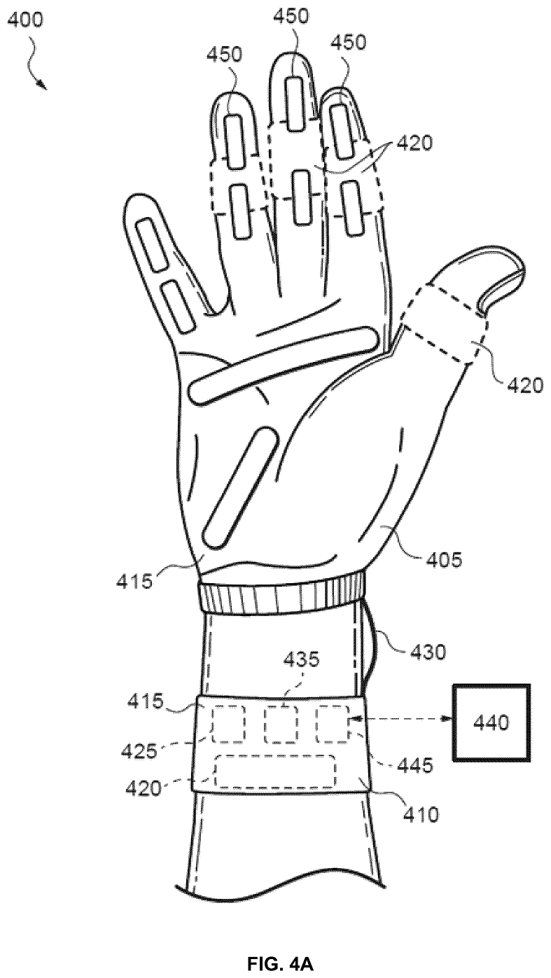

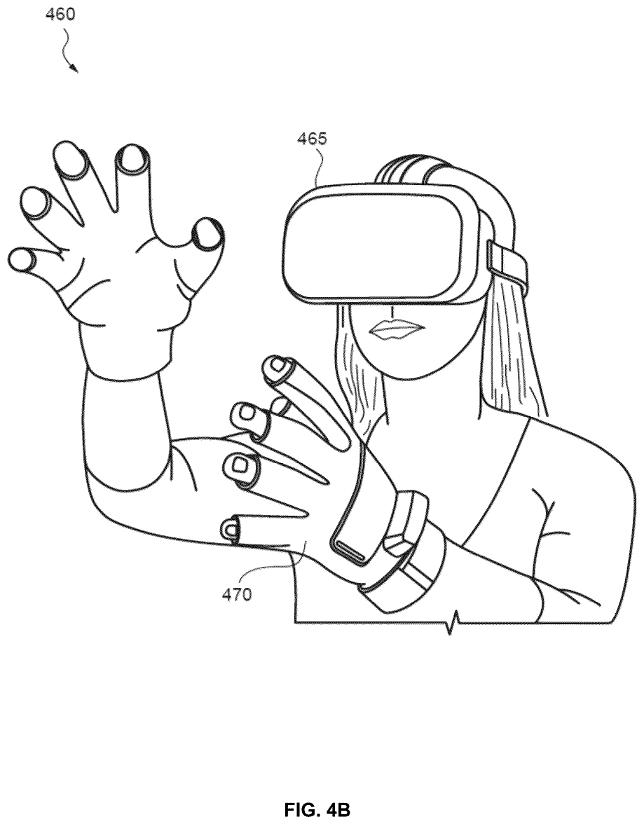

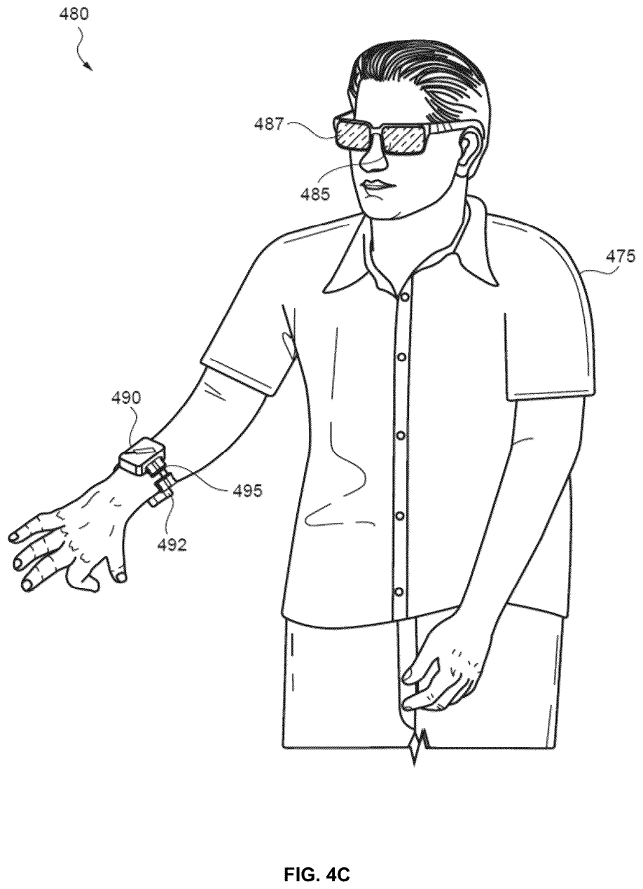

Haptic feedback may be provided by interfaces positioned within a user's environment (e.g., chairs, tables, floors) and/or interfaces on articles that may be worn or carried by a user (e.g., gloves, wristbands). As an example, FIG. 4A illustrates a vibrotactile system 400 in the form of a wearable glove (haptic device 405) and wristband (haptic device 410). Haptic device 405 and haptic device 410 are shown as examples of wearable devices that include a flexible, wearable textile material 415 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 420 may be positioned at least partially within one or more corresponding pockets formed in textile material 415 of vibrotactile system 400. Vibrotactile devices 420 may be positioned in locations to provide a vibrating sensation (e.g., haptic feedback) to a user of vibrotactile system 400. For example, vibrotactile devices 420 may be positioned against the user's finger(s), thumb, or wrist, as shown in FIG. 4A. Vibrotactile devices 420 may, in some examples, be sufficiently flexible to conform to or bend with the user's corresponding body part(s).

A power source 425 (e.g., a battery) for applying a voltage to the vibrotactile devices 420 for activation thereof may be electrically coupled to vibrotactile devices 420, such as via conductive wiring 430. In some examples, each of vibrotactile devices 420 may be independently electrically coupled to power source 425 for individual activation. In some embodiments, a processor 435 may be operatively coupled to power source 425 and configured (e.g., programmed) to control activation of vibrotactile devices 420.

Vibrotactile system 400 may be implemented in a variety of ways. In some examples, vibrotactile system 400 may be a standalone system with integral subsystems and components for operation independent of other devices and systems. As another example, vibrotactile system 400 may be configured for interaction with another device or system 440. For example, vibrotactile system 400 may, in some examples, include a communications interface 445 for receiving and/or sending signals to the other device or system 440. The other device or system 440 may be a mobile device, a gaming console, an extended reality (e.g., virtual reality, augmented reality, mixed reality) device, a personal computer, a tablet computer, a network device (e.g., a modem, a router), and a handheld controller. Communications interface 445 may enable communications between vibrotactile system 400 and the other device or system 440 via a wireless (e.g., Wi-Fi, Bluetooth, cellular, radio) link or a wired link. If present, communications interface 445 may be in communication with processor 435, such as to provide a signal to processor 435 to activate or deactivate one or more of the vibrotactile devices 420.

Vibrotactile system 400 may optionally include other subsystems and components, such as touch-sensitive pads 450, pressure sensors, motion sensors, position sensors, lighting elements, and/or user interface elements (e.g., an on/off button, a vibration control element). During use, vibrotactile devices 420 may be configured to be activated for a variety of different reasons, such as in response to the user's interaction with user interface elements, a signal from the motion or position sensors, a signal from the touch-sensitive pads 450, a signal from the pressure sensors, and a signal from the other device or system 440

Although power source 425, processor 435, and communications interface 445 are illustrated in FIG. 4A as being positioned in haptic device 410, the present disclosure is not so limited. For example, one or more of power source 425, processor 435, or communications interface 445 may be positioned within haptic device 405 or within another wearable textile.

Haptic wearables, such as those shown in and described in connection with FIG. 4A, may be implemented in a variety of types of extended reality systems and environments. FIG. 4B shows an example extended reality environment 460 including one head-mounted virtual reality display and two haptic devices (e.g., gloves), and in other embodiments any number and/or combination of these components and other components may be included in an extended reality system. For example, in some embodiments, there may be multiple head-mounted displays each having an associated haptic device, with each head-mounted display, and each haptic device communicating with the same console, portable computing device, or other computing system.

HMD 465 generally represents any type or form of virtual reality system, such as virtual reality system 350 in FIG. 3B. Haptic device 470 generally represents any type or form of wearable device, worn by a user of an extended reality system, that provides haptic feedback to the user to give the user the perception that he or she is physically engaging with a virtual object. In some embodiments, haptic device 470 may provide haptic feedback by applying vibration, motion, and/or force to the user. For example, haptic device 470 may limit or augment a user's movement. To give a specific example, haptic device 470 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 470 to send action requests to a console. Examples of action requests include, without limitation, requests to start an application and/or end the application and/or requests to perform a particular action within the application.

While haptic interfaces may be used with virtual reality systems, as shown in FIG. 4B, haptic interfaces may also be used with augmented reality systems, as shown in FIG. 4C. FIG. 4C is a perspective view of a user 475 interacting with an augmented reality system 480. In this example, user 475 may wear a pair of augmented reality glasses 485 that may have one or more displays 487 and that are paired with a haptic device 490. In this example, haptic device 490 may be a wristband that includes a plurality of band elements 492 and a tensioning mechanism 495 that connects band elements 492 to one another.

One or more of band elements 492 may include any type or form of actuator suitable for providing haptic feedback. For example, one or more of band elements 492 may be configured to provide one or more of various types of cutaneous feedback, including vibration, force, traction, texture, and/or temperature. To provide such feedback, band elements 492 may include one or more of various types of actuators. In one example, each of band elements 492 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 405, 410, 470, and 490 may include any suitable number and/or type of haptic transducer, sensor, and/or feedback mechanism. For example, haptic devices 405, 410, 470, and 490 may include one or more mechanical transducers, piezoelectric transducers, and/or fluidic transducers. Haptic devices 405, 410, 470, and 490 may also include various combinations of different types and forms of transducers that work together or independently to enhance a user's extended reality experience. In one example, each of band elements 492 of haptic device 490 may include a vibrotactor (e.g., a vibrotactile actuator) configured to vibrate in unison or independently to provide one or more various types of haptic sensations to a user.

### Learning and Recognizing Object-Centered Routines

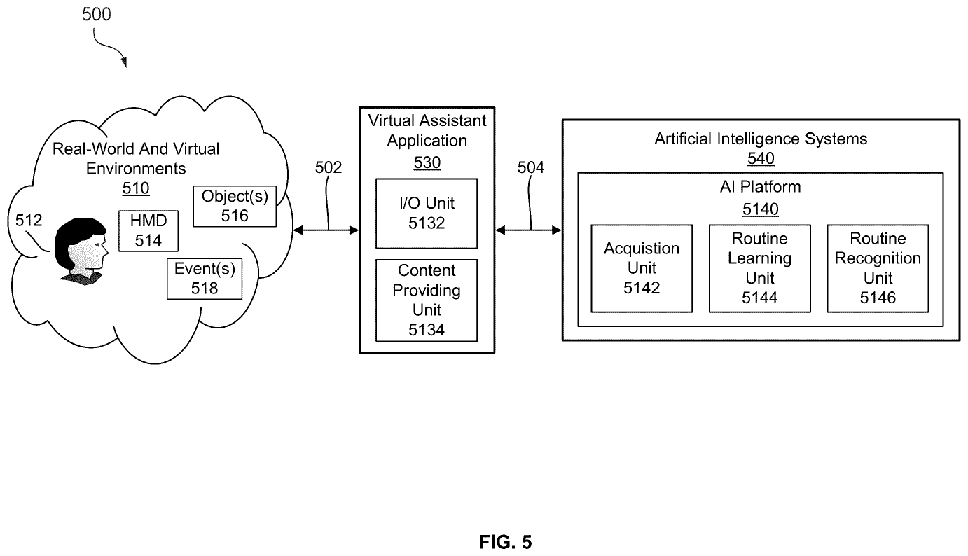

FIG. 5 illustrates an embodiment of an extended reality system 500. As shown in FIG. 5, the extended reality system 500 includes real-world and virtual environments 510 (“environments 510”), a virtual assistant application 530, and AI systems 540. In some embodiments, the extended reality system 500 forms part of a network environment, such as the network environment 100 described above with respect to FIG. 1. The environments 510 can include a user 512 wearing HMD 514 and one or more objects 516. In some embodiments, one or more events 518 can occur and exist in the environments 510. For example, one or more ambient sounds, ambient lights, and/or other users can occur or exist in the environments 510. The user 512 wearing HMD 514 can perform one or more activities in the environments 510. For example, the user 512 can perform a sequence of actions, interact with the one or more objects 516, and/or interact with, initiate, or react to the one or more events 518 in the environments 510. The virtual environment of the environments 510 can be provided by the HMD 514. For example, the HMD 514 can generate the virtual environment and present it to the user on one or more displays and/or user interfaces. In some embodiments, the virtual environment of the environments 510 can be provided by another device. The virtual environment can be generated based on data received from the virtual assistant application 530 through a first communication channel 502. The HMD 514 can be configured to monitor the environments 510 to obtain information about the user 512, one or more objects 516, and one or more events 518 and send that information through the first communication channel 502 to the virtual assistant application 530. The HMD 514 can also be configured to receive content and information through the first communication channel 502 from the virtual assistant application 530 and present that content to the user 512 while the user 512 is performing activities in the environments 510. In some embodiments, the first communication channel 502 can be implemented as links 125 such as those described above with respect to FIG. 1.

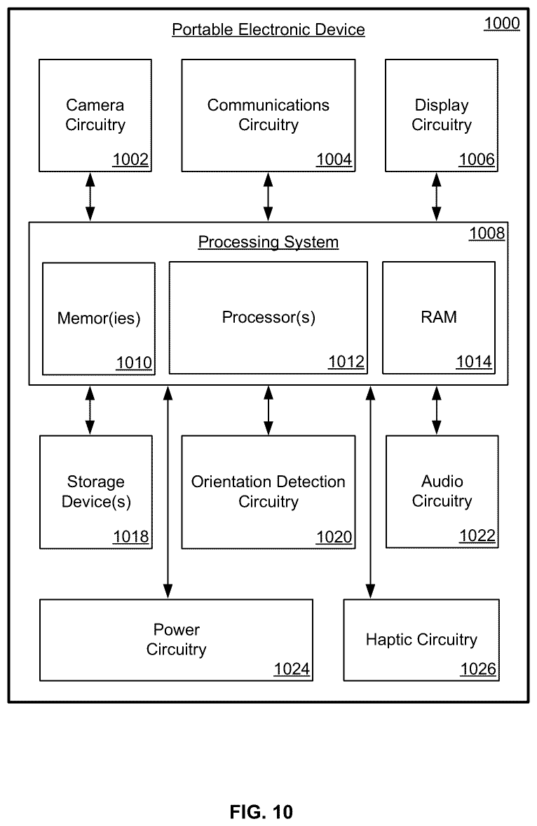

In some embodiments, the user 512 can perform activities while holding or wearing a computing device in addition to HMD 514 or instead of HMD 514. The computing device can be configured to monitor the user's activities and present content to the user in response to those activities. The computing device can be implemented as any device described above or the portable electronic device 1000 as shown in FIG. 10. In some embodiments, the computing device can be implemented as a wearable device (e.g., an HMD, smart eyeglasses, smart watch, and smart clothing), communication device (e.g., a smart, cellular, mobile, wireless, portable, and/or radio telephone), and/or portable computing device (e.g., a tablet, phablet, notebook, and laptop computer; and a personal digital assistant). The foregoing implementations are not intended to be limiting and the computing device can be any kind of electronic device that is configured to provide an extended reality system using a part of or all of the methods disclosed herein.

The virtual assistant application 530 can be configured as the virtual assistant application 130 described above with respect to FIG. 1. The virtual assistant application 530 can be incorporated in a client system, such as client system 105 as described above with respect to FIG. 1. In some embodiments, the virtual assistant application 530 can be incorporated in HMD 514. In this case, the first communication channel 502 can be a communication channel within the HMD 514. The virtual assistant application 530 can be configured with hardware and/or software suitable for performing the functions of the virtual assistant application 530. For example, the virtual assistant application 530 can include one or more processors and one or more software applications that are configured to perform the functions of the virtual assistant application 530. In some embodiments, the virtual assistant application 530 can serve as an interface between the real-world and virtual environments 510.

The virtual assistant application 530 includes an input/output (I/O) unit 5132 and a content-providing unit 5134. The I/O unit 5132 is configured to receive the information about the user 512, one or more objects 516, and one or more events 518 from the HMD 514 through the first communication channel 502. In some embodiments, the I/O unit 5132 can be configured to receive information about the user 512, one or more objects 516, and one or more events 518 from one or more sensors, such as the one or more sensors 215 as described above with respect to FIG. 2A or other communication channels. The I/O unit 5132 is further configured to format the information into a format suitable for other system components (e.g., AI systems 540). In some embodiments, the information about the user 512, one or more objects 516, and one or more events 518 is received as raw sensory data and the I/O unit 5132 is configured to format that raw sensory data into formats for suitable further processing, such as image data for image recognition, audio data for natural language processing, and the like. The I/O unit 5132 is further configured to send the formatted information through the second communication channel 504 to AI systems 540.

The content-providing unit 5134 is configured to provide content to the HMD 514 for presentation to the user 512. In some embodiments, the content-providing unit 5134 can also be configured to provide content to one or more other devices. The content can be the extended reality content 225 described above with respect to FIG. 2A. In some embodiments, the content can include a user interface that allow a user to interact with the virtual assistant application 530 and other audio/visual content such as audio, images, video, graphics, Internet-based content (e.g., webpages and application data), and the like. The content can be received from AI systems 540 through the second communication channel 504. In some embodiments, the content can be received from other sources and other communication channels.

AI systems 540 can be configured to enable the extended reality system 500 to learn and recognize one or more object-centered routines. In some embodiments, AI systems 540 can be configured as AI systems 140 described above with respect to FIG. 1. AI systems 540 can be incorporated in a virtual assistant engine, such as virtual assistant engine 110 as described above with respect to FIG. 1. In some embodiments, AI systems 540 can be incorporated in HMD 514. AI systems 540 can be configured with hardware and/or software suitable for performing the functions of AI systems 540. For example, AI systems 540 can include one or more processors and one or more software applications that are configured to enable the extended reality system 500 to learn and recognize one or more object-centered routines. In some embodiments, processing performed by AI systems 540 can be distributed across a plurality of computing devices, such as a distributed computing network, a data center, or a cloud computing system.

In some embodiments, AI systems 540 can be implemented in a computing device, such as any of the devices described above or the portable electronic device 1000 as shown in FIG. 10. In some embodiments, the computing device can be implemented as a wearable device (e.g., an HMD, smart eyeglasses, smart watch, and smart clothing), communication device (e.g., a smart, cellular, mobile, wireless, portable, and/or radio telephone), and/or portable computing device (e.g., a tablet computer, a notebook computer, a laptop computer, and/or a personal digital assistant). The foregoing implementations are not intended to be limiting and the computing device can be any kind of electronic device that is configured to provide an extended reality system using a part of or all of the methods disclosed herein.

AI systems 540 includes an AI platform 5140, which can be a machine-learning-based system configured to learn and recognize one or more object-centered routines. The AI platform 5140 includes an acquisition unit 5142, a routine learning unit 5144, a routine recognition unit 5146, and a user control unit 5148. The AI platform 5140 can include one or more special-purpose or general-purpose processors. Such special-purpose processors can include processors that are specifically designed to perform the functions of the acquisition unit 5142, the routine learning unit 5144, the routine recognition unit 5146, and the user control unit 5148. Additionally, each of the acquisition unit 5142, the routine learning unit 5144, the routine recognition unit 5146, and the user control unit 5148 can include one or more special-purpose or general-purpose processors that are specifically designed to perform the functions of those units. Such special-purpose processors can be application-specific integrated circuits (ASICs) or field-programmable gate arrays (FPGAs) which are general-purpose components that are physically and electrically configured to perform the functions detailed herein. Such general-purpose processors can execute special-purpose software that is stored using one or more non-transitory processor-readable mediums, such as random-access memory (RAM), flash memory, a hard disk drive (HDD), or a solid-state drive (SSD). Further, the functions of the components of the AI platform 5140 can be implemented using a cloud-computing platform, which is operated by a separate cloud-service provider that executes code and provides storage for clients.

People typically perform activities in accordance with one or more routines. These routines often involve a person interacting with a physical object located in their surroundings. For example, a person performing a routine can use the physical object in their routine or their daily routine can revolve around the physical object. The AI platform 5140 can learn a person's routines and recognize them when the person later performs them. In some embodiments, the AI platform 5140 can trigger one or more automations in response to recognizing that a routine is being and/or has been performed. The AI platform 5140 can learn a person's routine based on a sequence of actions performed by the person, interactions the person has with objects in the person's surroundings, and the person's interactions with, initiations of, and/or reactions to events occurring in the person's surroundings.

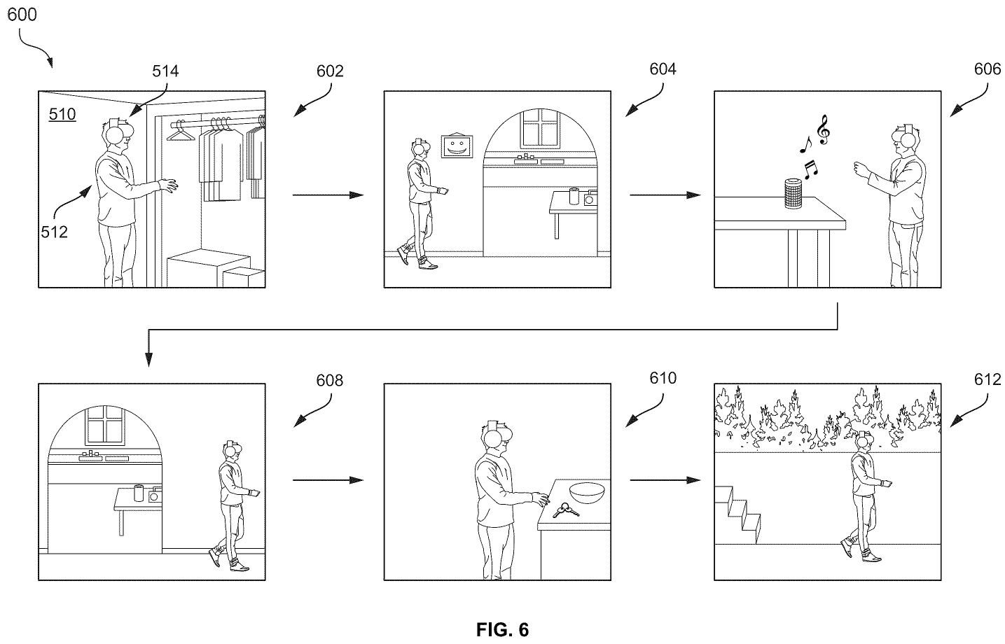

The acquisition unit 5142 is configured to recognize activities of a routine performed by the user 512 in and within the environments 510. A routine can include one or more activities performed by the user 512 in a real-world environment of the environments 510 while the user 512 is wearing HMD 514. For example, a routine can include the user 512 performing a sequence of actions, interacting with the one or more objects 516, and/or interacting with, initiating, or reacting to the one or more events 518 in the environments 510. In some embodiments, the sequence of actions includes interacting with the one or more objects 516 and/or interacting with, initiating, or reacting to the one or more events 518. In some embodiments, the user 512 can interact with the one or more objects 516 and/or with the In some embodiments, the activities can be performed by the user 512 habitually, periodically, and/or at a set frequency (e.g., once per day). For example, as shown in FIG. 6, the user 512 in environments 510 can start a daily routine in their bedroom by waking up every day at 6:30 AM and putting on HMD 514. After putting on HMD 514, the user 512 can, at scene 602, pick out clothes from their closet and get dressed. The user 512 can then, at scenes 604 and 606, walk from their bedroom to the kitchen and turn on a media playback device (e.g., a stereo receiver, a smart speaker, a television) in the kitchen. The user 512 can then, at scenes 608, 610, and 612, walk from the kitchen to the entrance of their house, pick up their car keys, and leave their house.

In some embodiments, in order to recognize the activities of the routine, the acquisition unit 5142 is configured to collect data from HMD 514 that includes characteristics of the user 512, one or more objects 516, and one or more events 518 in the environments 510. In some embodiments, the data can be collected using one or more sensors of HMD 514 such as the one or more sensors 215 as described with respect to FIG. 2A. For example, the one or more sensors 215 can capture images, video, and/or audio of the user 512, one or more objects 516, and one or more events 518 in the environments 510 and send image, video, and/or audio information corresponding to the images, video, and audio through the first communication channel 502 to the virtual assistant application 530. The I/O unit 5132 of the virtual assistant application 530 can be configured to receive the image, video, and audio information and format the information into one or more formats suitable for AI systems 540. In some embodiments, the I/O unit 5132 can be configured to format the information into one or more formats suitable for image recognition processing, video recognition processing, audio recognition processing, and the like. The I/O unit 5132 can be further configured to send the formatted information through the second communication channel 504 to AI systems 540.

The acquisition unit 5142 is configured to start collecting the data from HMD 514 when HMD 514 is powered on and when the user 512 puts HMD 514 on and stop collecting the data from HMD 514 when either HMD 514 is powered off or the user 512 takes HMD 514 off. The acquisition unit 5142 is also configured to start collecting the data from HMD 514 and stop collecting the data from HMD 514 in response to one or more natural language statements, gazes, and/or gestures made by the user 512 while the wearing HMD 514. In some embodiments, the acquisition unit 5142 can monitor HMD 514 for one or more natural language statements, gazes, and/or gestures made by the user 512 while the user 512 is interacting with and within environments 510 that reflect user's 512 desire for data to be collected (e.g., when a new routine is being learned or recognized) and/or for data to stop being collected (e.g., after a routine has been or recognized). For example, while the user 512 is interacting with and within environments 510, the user 512 can utter the phrase “I'd like to demonstrate my morning weekday routine” and/or “My morning weekday routine has been demonstrated” and HMD 514 can respectively start and/or stop the collecting the data in response thereto.

In some embodiments, the acquisition unit 5142 can be configured to determine whether or not the user 512 has permitted the acquisition unit 5142 to collect data. In some embodiments, the acquisition unit 5142 is configured to present a data collection authorization message to the user 512 on HMD 514 and request the user's 512 permission for the acquisition unit 5142 to collect the data. The data collection authorization message can serve to inform the user 512 of what types or kinds of data that can be collected, how and when that data will be collected, and how that data will be used by the extended reality system 500 and/or third parties. In some embodiments, the user 512 can authorize data collection and/or deny data collection authorization using one or more natural language statements, gazes, and/or gestures made by the user 512. In some embodiments, the acquisition unit 5142 can request the user's 512 authorization on a periodic basis (e.g., one a month, whenever software is updated, and the like).

In some embodiments, the acquisition unit 5142 is configured to use the collected data to recognize actions performed by the user 512, the one or more objects 516, and the one or more events 518 in the environments 510 using the image, video, and audio information. In some embodiments, the actions can include actions performed by the user 512 interacting within and within environments 510, interacting within the one or more objects 516, and/or interacting with, initiating, and/or reacting to the one or more events 518. The actions performed by the user 512, the one or more objects 512, and the one or more events 518 in the environments 510 can be recognized using one or more recognition algorithms such as image recognition algorithms, video recognition algorithms, semantic segmentation algorithms, instance segmentation algorithms, human activity recognition algorithms, audio recognition algorithms, speech recognition algorithms, event recognition algorithms, and the like.

In some embodiments, the acquisition unit 5142 includes one or more machine learning models (e.g., neural networks, support vector machines, and/or classifiers) that are trained to detect and recognize actions performed by the user 512, the one or more objects 516, and the one or more events 518 in the environments 510. In some embodiments, the one or more machine learning models are trained to detect and recognize the user 512 interacting in and within environments 510, interacting with the one or more objects 516, and/or interacting with, initiating, or reacting to the one or more events 518 in the environments 510. The one or more machine learning models can be trained to recognize actions based on training data. The training data can include characteristics of previously recognized actions. In some embodiments, the one or more machine-learning models can be trained by applying supervised learning or semi-supervised learning techniques using training data that includes labeled observations, where each labeled observation includes an action with various characteristics correlated to other actions with similar characteristics. In some embodiments, the one or more machine learning models include one or more pre-trained models such as models in the GluonCV and GluonNLP toolkits. In some embodiments, the one or more machine learning models may be fine-tuned based on activities performed by the user 512 while interacting with and within environments 510, interacting with the one or more objects 516, and/or interacting with, initiating, and/or reacting to the one or more events 518.

In some embodiments, the acquisition unit 5142 is configured to store information representing the recognized actions performed by the user 512, the one or more objects 516, and the one or more events 518 in the environments 510 along with the formatted image, video, and audio information in one or more data structures and store the one or more data structures in one or more memories (not shown) or storage devices (not shown) for AI systems 540. In some embodiments, each data structure can include information representing one or more recognized actions performed by the user 512 interacting within and within environments 510, one or more recognized objects of the one or more objects 516, one or more recognized actions performed by the user 512 interacting with the one or more recognized objects, one or more recognized events of the one or more events 518, and one or more recognized actions performed by the user 512 interacting with, initiating, and/or reacting to the one or more recognized events.

The routine learning unit 5144 is configured to learn routines and modify learned routines using the recognized actions performed by the user 512, the one or more objects 516, and the one or more events 518 in the environments 510 along with the formatted image, video, and audio information. In some embodiments, the routine learning unit 5144 can retrieve a stored data structure from the one or more memories and/or storage devices for AI systems 540 and use the information stored therein to learn routines and modify learned routines.

The routine learning unit 5144 can learn routines and modify learned routines in response to a request received from the user 512. In some embodiments, the routine learning unit 5144 can be configured to monitor the HMD 514 for one or more natural language statements, gazes, and/or gestures made by the user 512 while the user 512 is interacting with and within environments 510 that reflect user's 512 desire to learn a new routine and/or modify a learned routine. For example, while the user 512 is interacting with and within environments 510, the user 512 can utter the phrase “I'd like to demonstrate my morning weekday routine” and the routine learning unit 5144 can recognize this natural language statement as a request to learn a new routine. Similarly, while the user 512 is interacting with and within environments 510, the user 512 can utter the phrase “I'd like to modify my morning weekday routine” and the routine learning unit 5144 can recognize this natural language statement as a request to modify a learned routine.

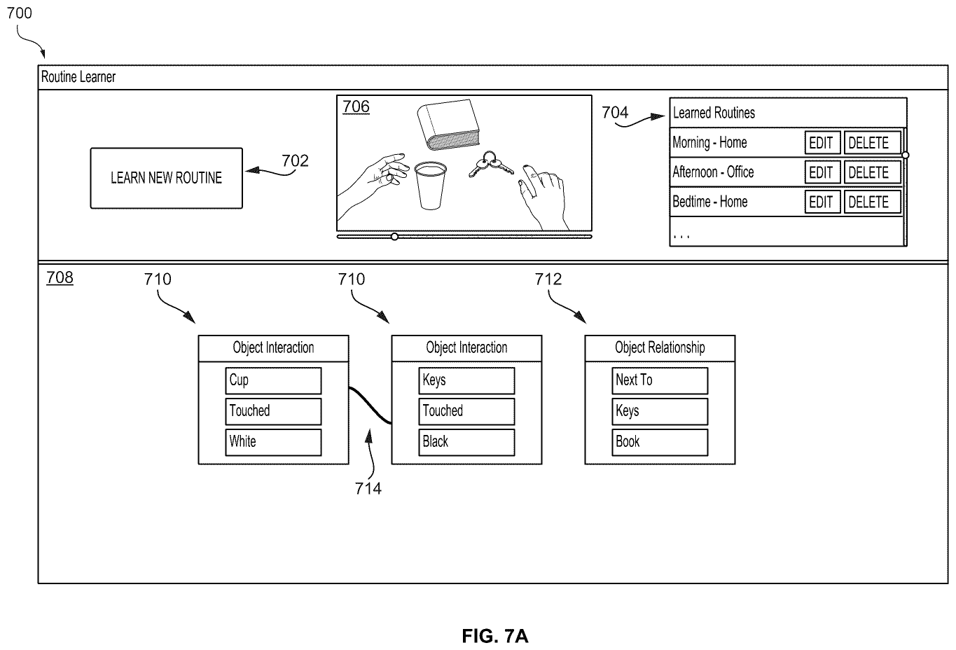

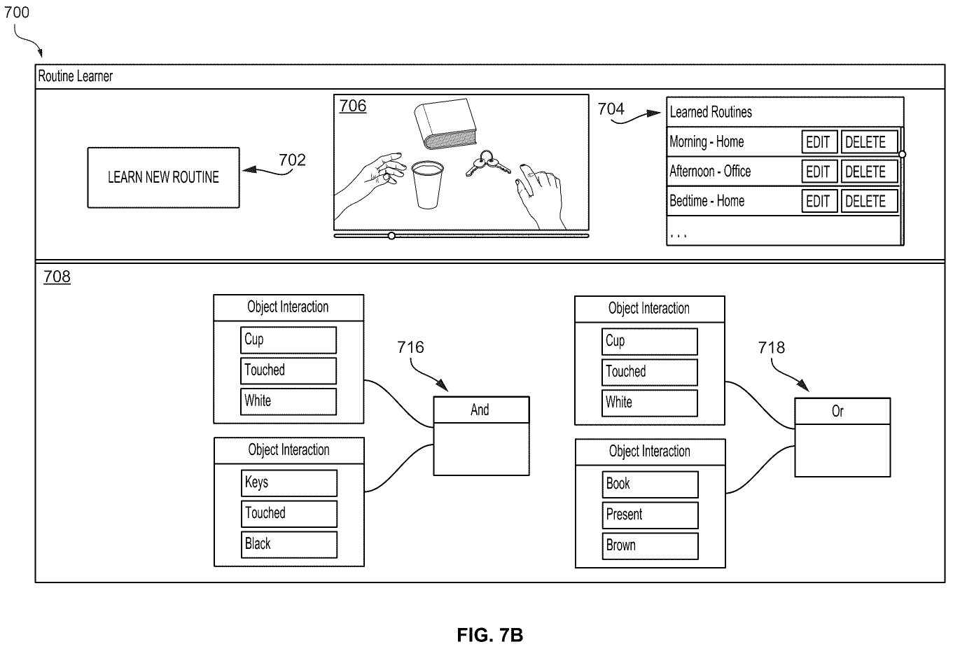

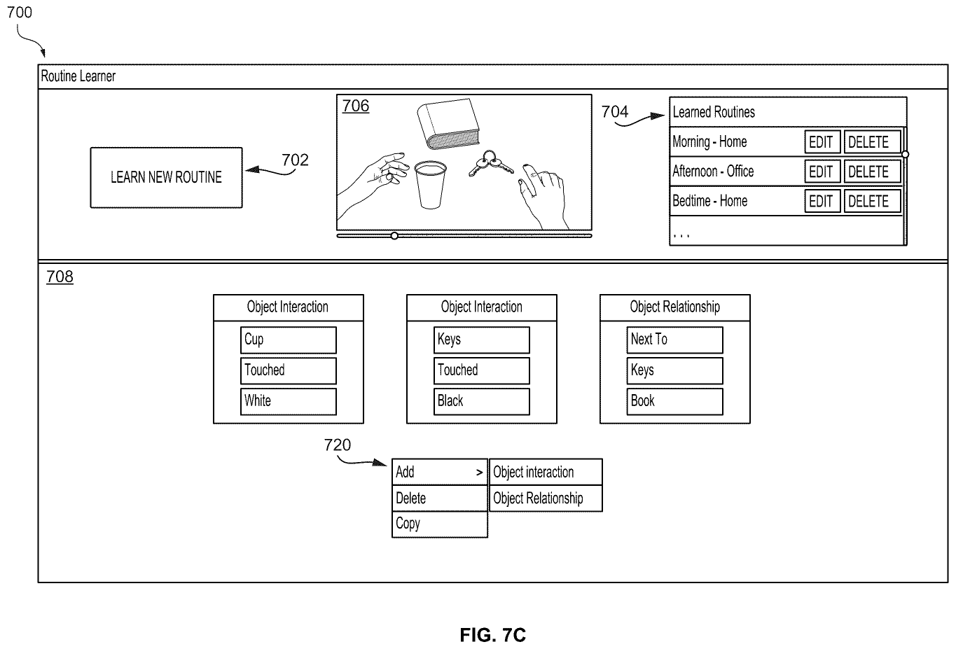

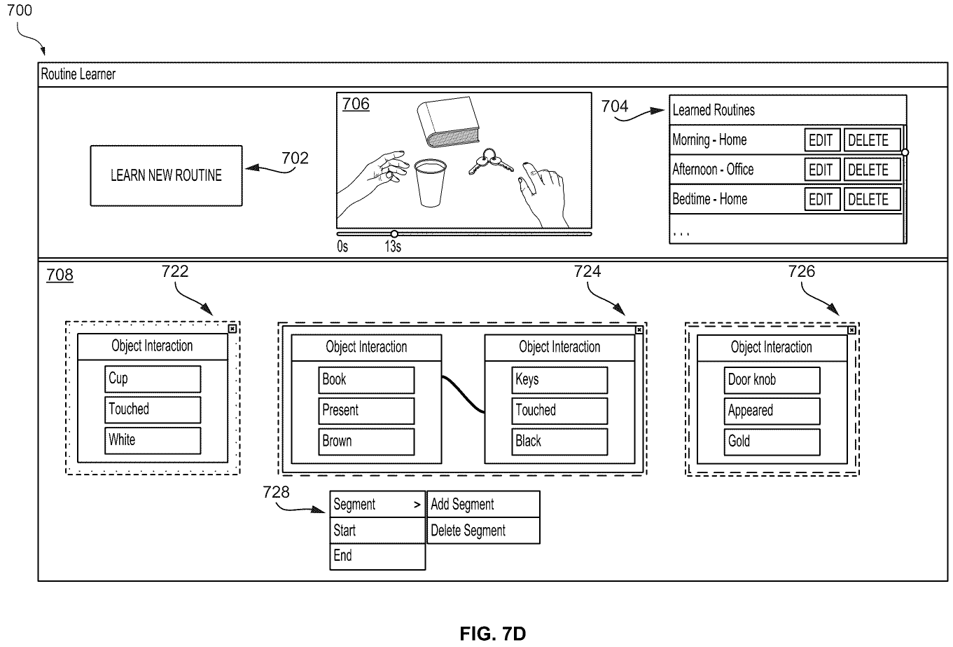

Upon receiving a request to learn a new routine and/or modify a learned routine, the routine learning unit 5144 can present a user interface 700 (FIGS. 7A-7D) on the display of HMD 514. As shown in FIGS. 7A-7D, the user interface 700 is configured with selectable options including an option to learn a new routine 702 and/or an option to modify a learned routine 704. In some embodiments, the user 512 can select the option to learn a new routine 702 and/or the option to modify a learned routine 704 using one or more natural language statements, gazes, and/or gestures. For example, the user 512 can select the learn a new routine option 702 by gazing at the “Learn New Routine” button and uttering the phrase “I'd like to my routine to be learned.” Similarly, the user 512 can select the modify a learned routine 704 option by gazing at “Learned Routines” table and uttering the phrase “I'd like to edit my “Morning—Home” routine.

Upon the user 512 selecting the option to learn a new routine 702, the routine learning unit 5144 can enter into a routine learning mode in which the routine learning unit 5144 can learn a new routine by presenting the user 512 with a message on the display of HMD 514 that instructs the user 512 to begin demonstrating their routine, instructing the acquisition unit 5142 to recognize activities of the routine performed by the user 512 as described above, presenting a video 706 of the user 512 performing the routine in the user interface 700, and presenting a visual graph 708 in the user interface 700 so that the user 512 can visually define the routine. Upon the user 512 selecting the option to modify a learned routine 704, the routine learning unit 5144 can enter in a routine modification mode in which the routine learning unit 5144 can modify a learned routine by retrieving one or more stored learned routines from the one or more memories and/or storage devices for AI systems 540, presenting a video 706 of the user 512 performing the learned routine in the user interface 700, and presenting a visual graph 708 in the user interface 700 so that the user 512 can visually modify a learned routine. In some embodiments, the user 512 can visually define and/or visually modify the routine using visual graph 708 and one or more natural language statements, gazes, and/or gestures.

The user 512 can visually define and/or visually modify the routine using the visual graph 708 by defining one or more nodes 710, 712, one or more relationships 714, 716, 718 between the one or more nodes 710, 712, and one or more segments 722, 724, 726 of the one or more nodes 710, 712 in the visual graph 708. The one or more nodes can include an object interaction node 710 and/or an object relationship node 712. The object interaction node 710 can represent the user's 512 interaction with an object while the user 512 performs the routine. The user 512 can define the object interaction node 710 by selecting an object from a list of objects the user 512 interacted with while performing the routine, selecting the type of interaction from a predetermined list of interactions, and selecting a color of the object from a predetermined list of colors. The list of objects the user 512 interacted with while performing the routine can be determined from the one or more objects 516 recognized by the acquisition unit 5142. The predetermined list of interactions can include an interaction in which the selected object was been touched by the user 512 while the user 512 performed the routine, an interaction in which the selected object newly appeared in the user's 512 view while the user 512 performed the routine, an interaction in which the selected object disappeared from the user's 512 view while the user 512 performed the routine, and an interaction in which the selected object remained present in the user's 512 view while the user 512 performed the routine. The predetermined list of colors can include white, black, gray, red, green, blue, yellow, and/or brown.

The object relationship node 712 can represent the user's 512 interaction with a group of objects that are in a spatial relationship with each other while the user 512 performs the routine. The user 512 can define the object relationship node 712 by selecting a first object and a second object from the list of objects the user 512 interacted with while performing the routine and selecting the type of spatial relationship between the first and second objects as either a next to (i.e., the two objects are adjacent to each other) relationship or an in front of relationship (i.e., one of the objects is in front of the other object).

As shown in FIGS. 7A and 7B, the user 512 can specify a sequential relationship and/or logical relationship two or more object interaction nodes 710. The user 512 can define that there is a sequential relationship between a first object interaction node 710 and a second object interaction node 710 by arranging the first object interaction node 710 and the second object interaction node 710 to a sequence between the first object interaction node 710 and the second object interaction node 710 (e.g., moving the first objection interaction node 710 to the left of the second object interaction node 710 in the visual graph 708) adding a sequential relationship icon 714 between the first and second object interaction nodes 710. The sequential relationship icon 714 indicates that while performing the routine, the user 512 interacted with the selected object for the first object interaction node 710 before the user 512 interacted with the selected object for the second object interaction node 710. Similarly, the user 512 can define that there is a logical relationship between a first object interaction node 710 and a second object interaction node 710 by arranging the first object interaction node 710 adjacent to the second object interaction node 710 (e.g., moving the first objection interaction node 710 close to the second object interaction node 710 in the visual graph 708) adding a logical relationship icon between the first and second object interaction nodes 710. In some embodiments, the logical relationship icon can be an And logical relationship icon 716 that indicates that while performing the routine, the user 512 interacted with both of the selected objects or the logical relationship icon can be an Or logical relationship icon 718 that indicates that while performing the routine, the user 512 interacted with one or both of the selected objects.

In some embodiments, as shown in FIG. 7C, the user 512 can add, delete, and/or copy one or more new object interaction and/or relationship nodes using node menu 720. In some embodiments, the node menu 720 can be launched by the user 512 and/or can be a fixed feature of the visual graph 708.

Once nodes have been defined and relationships between the nodes have been specified, as shown in FIG. 7D, the user 512 can arrange the nodes into one or more segments 722, 724, 726. The segments can include a start segment 722, one or more intermediate segments 724, and an end segment 726. The start segment 722 can represent the start of the routine performed by the user 512 and the end segment 726 can represent the end of the routine performed by the user 512. The one or more intermediate segments 724 can represent a middle of the routine performed by the user 512. Each segment 722, 724, 726 can include one or more nodes and the relationship between those nodes. For example, the start segment 722 can include a single object interaction node which defines an object and the user's 512 interaction with the object at the start of the routine. Similarly, the one or more intermediate segments 724 can include two object interaction nodes that are in a sequential relationship with each other and define objects and the user's 512 interaction with the objects after the routine has started and the end segment 726 can include a single object interaction node which defines an object and the user's 512 interaction with the object at the end of the routine.

In some embodiments, as shown in FIG. 7D, the user 512 can add or delete a segment and/or specify the start and end segments using segment menu 728. In some embodiments, the segment menu 720 can be launched by the user 512 and/or can be a fixed feature of the visual graph 708.

Once the user has visually defined and/or visually modified a routine, the routine learning unit 5144 can store the visual graph 708 in a data structure in the one or more memories and/or storage devices for AI systems 540. For example, a data structure for a routine can include a name for the routine, the nodes of the visual graph 708 for the routine, the relationships between nodes as included in the visual graph 708 for the routine, and the segments of the routine as arranged in the visual graph 708 for the routine in a data structure. The data structure for the routine can also include metadata that lists the objects included in the routine and the user's 512 interactions with the objects as reflected by the nodes, the relationships between nodes, and the segments of the routine. In this way, a routine can be learned and a data structure for the routine can be retrieved based on the objects included in the routine and the user's interactions with those objects.

The routine recognition unit 5146 is configured to recognize learned routines based on the actions performed by the user 512, the one or more objects 516, and the one or more events 518 in the environments 510 that have been recognized by the acquisition unit 5142. As discussed above, the actions can include actions performed by the user 512 interacting within and within environments 510, interacting within the one or more objects 516, and/or interacting with, initiating, and/or reacting to the one or more events 518. In order to recognize learned routines, the routine recognition unit 5146 is configured to compare the recognized actions performed by the user 512 and the recognized one or more objects 516 to the objects and the user's 512 interactions included in the metadata for each stored data structure. The routine recognition unit 5146 is further configured to determine whether or not any of the recognized actions performed by the user 512 and the recognized one or more objects 516 match any of the objects and user's 512 interactions listed in the metadata for each stored data structure. The routine recognition unit 5146 is further configured to retrieve any stored data structures having metadata in which at least one object and/or at least one user interaction included in the respective metadata matches at least one recognized object of the recognized one or more objects 516 and at least one recognized user interaction of the recognized user 512 interactions.

If a single stored data structure is retrieved, the routine recognition unit 5146 is further configured to recognize that the actions performed by the user 512, the one or more objects 516, and the one or more events 518 in the environments 510 that have been recognized by the acquisition unit 5142 correspond to that retrieved data structure. If multiple stored data structures are retrieved, the routine recognition unit 5146 is further configured to determine which retrieved data structure of the retrieved data structures the actions performed by the user 512, the one or more objects 516, and the one or more events 518 in the environments 510 that have been recognized by the acquisition unit 5142 most correspond to. In some embodiments, the routine recognition unit 5146 is configured to make this determination by counting a number of objects and user interactions included in the metadata for each retrieved data structure that match at least one recognized object of the recognized one or more objects 516 and at least one recognized user interaction of the recognized user 512 interactions and determining which retrieved data structure includes the greatest number of matching objects and user interactions included its metadata. In some embodiments, the routine recognition unit 5146 can determine which retrieved data structure of the retrieved data structures the actions performed by the user 512, the one or more objects 516, and the one or more events 518 in the environments 510 that have been recognized by the acquisition unit 5142 most correspond to using a similarity measure.

In some embodiments, in response to determining that the actions performed by the user 512, the one or more objects 516, and the one or more events 518 in the environments 510 that have been recognized by the acquisition unit 5142 correspond to a stored data structure, the routine recognition unit 5146 can trigger one or more automations for the routine of the stored data structure. In some embodiments, the one or more automations include presenting information associated with the routine on the display of HMD 514. For example, if the routine recognition unit 5146 detects that the user 512 is performing the routine described above with respect to FIG. 6, the routine recognition unit 5146 can present traffic information on the display of HMD 514 to assist the user 512 during their commute. In some embodiments, the one or more automations include presenting other content to the user 512 such as the extended reality content 225 described above with respect to FIG. 2A.

### Illustrative Methods

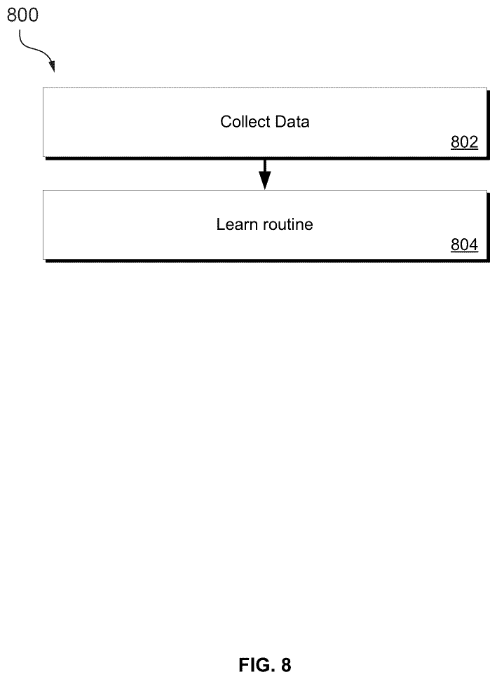

FIG. 8 is an illustration of a flowchart of an example process 800 for learning object-centered routines in accordance with various embodiments. In some examples, the process is implemented by client system 200 described above, extended reality system 500 described above, or a portable electronic device, such as portable electronic device 1000 as shown in FIG. 10. The process 800 can be implemented in software or hardware or any combination thereof.

At block 802, data is collected. In some embodiments, the collected data corresponds to a routine performed by a user wearing an HMD (e.g., HMD 514). In some embodiments, the collected data includes characteristics of the user, one or more objects, and one or more events in a real-world environment, a virtual environment, or a combination thereof (e.g., environments 510). In some embodiments, the data can be collected using one or more sensors of the HMD such as the one or more sensors 215 as described with respect to FIG. 2A. For example, the data can include images, video, and/or audio of the user, one or more objects, and one or more events in the environments 510. In some embodiments, the data can be sent through a communication channel such as the first communication channel 502 to an application such as the virtual assistant application 530. The application can be configured to receive the data and format the data into one or more formats suitable for AI systems such as AI systems 540. In some embodiments, the data can be formatted into one or more formats suitable for image recognition processing, video recognition processing, audio recognition processing, and the like. The formatted data can be sent through a second communication channel such as second communication channel 504 to the AI systems.

The data can be collected starting from when the HMD is powered on and when the user puts the HMD on and until either the HMD is powered off or the user takes the HMD off. Starting and stopping collection of the data can also occur in response to one or more natural language statements, gazes, and/or gestures made by the user while the wearing the HMD. In some embodiments, the one or more natural language statements, gazes, and/or gestures can be made by the user while the user is interacting with and within the environments that reflect user's desire for data to be collected (e.g., when a new routine is being learned or recognized) and/or for data to stop being collected (e.g., after a routine has been or recognized). For example, while the user is interacting with and within the environments, the user can utter the phrase “I'd like to demonstrate my morning weekday routine” and/or “My morning weekday routine has been demonstrated” and the HMD can respectively start and/or stop the collecting the data in response thereto.

In some embodiments, the collection of data can be contingent upon whether or not the user has permitted data collection. In some embodiments, a data collection authorization message that requests the user's permission to collect data can be presented to the user. The data collection authorization message can serve to inform the user of what types or kinds of data that can be collected, how and when that data will be collected, and how that data will be used by an extended reality system (e.g., extended reality system 500) and/or third parties. In some embodiments, the user can authorize data collection and/or deny data collection authorization using one or more natural language statements, gazes, and/or gestures made by the user. In some embodiments, the user's authorization can be requested on a periodic basis (e.g., one a month, whenever software is updated, and the like).

In some embodiments, the collected data is used to recognize actions performed by the user, the one or more objects, and the one or more events in the environments using the image, video, and audio information. In some embodiments, the actions can include actions performed by the user interacting within and within environments, interacting within the one or more objects, and/or interacting with, initiating, and/or reacting to the one or more events. The actions performed by the user, the one or more objects, and the one or more events in the environments can be recognized using one or more recognition algorithms such as image recognition algorithms, video recognition algorithms, semantic segmentation algorithms, instance segmentation algorithms, human activity recognition algorithms, audio recognition algorithms, speech recognition algorithms, event recognition algorithms, and the like.

In some embodiments, the actions can be detected and recognized with one or more machine learning models (e.g., neural networks, support vector machines, and/or classifiers) that are trained to detect and recognize actions performed by the user, the one or more objects, and the one or more events in the environments. In some embodiments, the one or more machine learning models are trained to detect and recognize the user interacting in and within environments, interacting with the one or more objects, and/or interacting with, initiating, or reacting to the one or more events in the environments. In some embodiments, the one or more machine learning models can be trained to recognize actions based on training data. The training data can include characteristics of previously recognized actions. In some embodiments, the one or more machine-learning models can be trained by applying supervised learning or semi-supervised learning techniques using training data that includes labeled observations, where each labeled observation includes an action with various characteristics correlated to other actions with similar characteristics. In some embodiments, the one or more machine learning models include one or more pre-trained models such as models in the GluonCV and GluonNLP toolkits. In some embodiments, the one or more machine learning models may be fine-tuned based on activities performed by the user while interacting with and within environments, interacting with the one or more objects, and/or interacting with, initiating, and/or reacting to the one or more events.

In some embodiments, the information representing the recognized actions performed by the user, the one or more objects, and the one or more events in the environments can be stored along with the formatted image, video, and audio information in one or more data structures and the one or more data structures can be stored in one or more memories or storage devices for the AI systems. In some embodiments, each data structure can include information representing one or more recognized actions performed by the user interacting within and within environments, one or more recognized objects of the one or more objects, one or more recognized actions performed by the user interacting with the one or more recognized objects, one or more recognized events of the one or more events, and one or more recognized actions performed by the user interacting with, initiating, and/or reacting to the one or more recognized events.

At block 804, a routine is learned from the collected data. In some embodiments, routines can be learned from the recognized actions performed by the user, the one or more objects, and the one or more events in the environments along with the formatted image, video, and audio information. In some embodiments, a stored data structure can be retrieved from the one or more memories and/or storage devices for the AI systems and the information stored therein can be used to learn routines.

A routine can be learned in response to a request received from the user. A request can be made using one or more natural language statements, gazes, and/or gestures received from the user while the user is interacting with and within the environments that reflect the user's desire to learn a new routine. For example, while the user is interacting with and within environments, the user can utter the phrase “I'd like to demonstrate my morning weekday routine” and this natural language statement can be recognized as a request to learn a new routine.

Upon receiving a request to learn a new routine, a user interface (e.g., the user interface 700 shown in FIGS. 7A-7D) can be presented to the user on the display of the HMD. The user interface is configured with selectable options including an option to learn a new routine. In some embodiments, the user can select the option to learn a new routine using one or more natural language statements, gazes, and/or gestures. For example, the user can select the learn a new routine option by gazing at the “Learn New Routine” button and uttering the phrase “I'd like to my routine to be learned.”

Upon the user selecting the option to learn a new routine, a routine learning mode can be entered into. In the routine learning mode, the user can be presented with a message on the display of the HMD that instructs the user to begin demonstrating their routine. Activities of the routine performed by the user can be recognized as described above and a video of the user performing the routine can be presented in the user interface. A visual graph such as visual graph 708 can be presented to the user in the user interface so that the user can visually define the routine. In some embodiments, the user can visually define the routine using visual graph and one or more natural language statements, gazes, and/or gestures.

The user can visually define using the visual graph by defining one or more nodes (e.g., nodes 710, 712), one or more relationships (e.g., relationships 714, 716, 718) between the one or more nodes, and one or more segments (e.g., segments 722, 724, 726) of the one or more nodes in the visual graph. The one or more nodes can include an object interaction node (e.g., node 710) and/or an object relationship node (e.g., node 712). The object interaction node can represent the user's interaction with an object while the user performs the routine. The user can define the object interaction node by selecting an object from a list of objects the user interacted with while performing the routine, selecting the type of interaction from a predetermined list of interactions, and selecting a color of the object from a predetermined list of colors. The list of objects the user interacted with while performing the routine can be determined from the one or more recognized objects. The predetermined list of interactions can include an interaction in which the selected object was been touched by the user while the user performed the routine, an interaction in which the selected object newly appeared in the user's view while the user performed the routine, an interaction in which the selected object disappeared from the user's view while the user performed the routine, and an interaction in which the selected object remained present in the user's view while the user performed the routine. The predetermined list of colors can include white, black, gray, red, green, blue, yellow, and/or brown.

The object relationship node can represent the user's interaction with a group of objects that are in a spatial relationship with each other while the user performs the routine. The user can define the object relationship node by selecting a first object and a second object from the list of objects the user interacted with while performing the routine and selecting the type of spatial relationship between the first and second objects as either a next to (i.e., the two objects are adjacent to each other) relationship or an in front of relationship (i.e., one of the objects is in front of the other object).

The user can specify a sequential relationship and/or logical relationship two or more object interaction nodes. The user can define that there is a sequential relationship between a first object interaction node and a second object interaction node by arranging the first object interaction node and the second object interaction node to a sequence between the first object interaction node and the second object interaction node (e.g., moving the first objection interaction node to the left of the second object interaction node in the visual graph) adding a sequential relationship icon (e.g., icon 714) between the first and second object interaction nodes. The sequential relationship icon indicates that while performing the routine, the user interacted with the selected object for the first object interaction node before the user interacted with the selected object for the second object interaction node. Similarly, the user can define that there is a logical relationship between a first object interaction node and a second object interaction node by arranging the first object interaction node adjacent to the second object interaction node (e.g., moving the first objection interaction node close to the second object interaction node in the visual graph) adding a logical relationship icon between the first and second object interaction nodes. In some embodiments, the logical relationship icon can be an AND logical relationship icon (e.g., icon 716) that indicates that while performing the routine, the user interacted with both of the selected objects or the logical relationship icon can be an OR logical relationship icon (e.g., icon 718) that indicates that while performing the routine, the user interacted with one or both of the selected objects.

In some embodiments, the user can add, delete, and/or copy one or more new object interaction and/or relationship nodes using node menu (e.g., menu 720). In some embodiments, the node menu can be launched by the user and/or can be a fixed feature of the visual graph.

Once nodes have been defined and relationships between the nodes have been specified, the user can arrange the nodes into one or more segments (e.g., segments 722, 724, 726). The segments can include a start segment (e.g., segment 722), one or more intermediate segments (e.g., segment 724), and an end segment (e.g., segment 726). The start segment can represent the start of the routine performed by the user and the end segment can represent the end of the routine performed by the user. The one or more intermediate segments can represent a middle of the routine performed by the user. Each segment can include one or more nodes and the relationship between those nodes. For example, the start segment can include a single object interaction node which defines an object and the user's interaction with the object at the start of the routine. Similarly, the one or more intermediate segments can include two object interaction nodes that are in a sequential relationship with each other and define objects and the user's interaction with the objects after the routine has started and the end segment can include a single object interaction node which defines an object and the user's interaction with the object at the end of the routine.

In some embodiments, the user can add or delete a segment and/or specify the start and end segments using segment menu (e.g., menu 728). In some embodiments, the segment menu can be launched by the user and/or can be a fixed feature of the visual graph.

Once the user has visually defined and/or visually modified a routine, the visual graph can be stored in a data structure that can be stored in the one or more memories and/or storage devices for the AI systems. For example, a data structure for a routine can include a name for the routine, the nodes of the visual graph for the routine, the relationships between nodes as included in the visual graph for the routine, and the segments of the routine as arranged in the visual graph for the routine in a data structure. The data structure for the routine can also include metadata that lists the objects included in the routine and the user's interactions with the objects as reflected by the nodes, the relationships between nodes, and the segments of the routine. In this way, a routine can be learned and a data structure for the routine can be retrieved based on the objects included in the routine and the user's interactions with those objects.

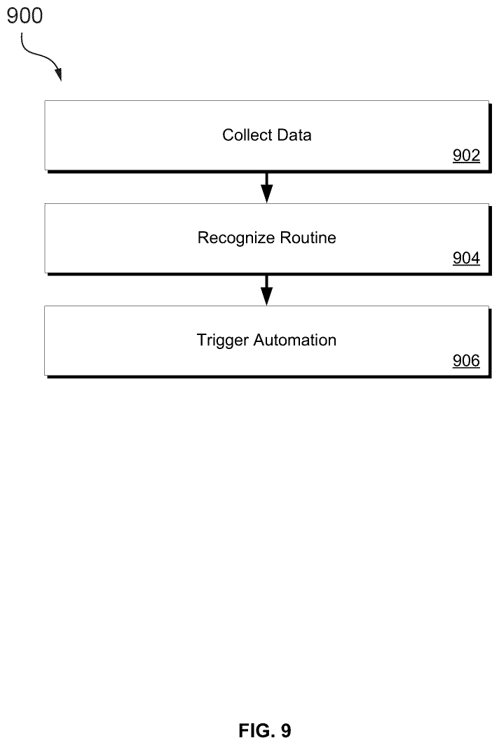

FIG. 9 is an illustration of a flowchart of an example process 900 for learning routines in accordance with various embodiments. In some examples, the process is implemented by client system 200 described above, extended reality system 500 described above, or a portable electronic device, such as portable electronic device 1000 as shown in FIG. 10. The process 900 can be implemented in software or hardware or any combination thereof.

At block 902, data is collected. The features of the data collection step have been described in above with respect to block 802. Accordingly, those features are not described again here.

At block 904, a routine is recognized from the collected data. In some embodiments, a routine can be recognized from the recognized actions performed by the user, the recognized one or more objects, and the one or more recognized events in the environments. In some embodiments, a stored data structure can be retrieved from the one or more memories and/or storage devices for the AI systems and the information stored therein can be used to recognize a routine.

As discussed above, the actions can include actions performed by the user interacting within and within environments, interacting within the one or more objects, and/or interacting with, initiating, and/or reacting to the one or more events. In order to recognize a learned routine, the recognized actions performed by the user and the recognized one or more objects can be compared to the objects and the user's interactions included in the metadata for each stored data structure. A determination can then be made whether or not any of the recognized actions performed by the user and the recognized one or more objects match any of the objects and user's interactions listed in the metadata for each stored data structure. Any stored data structures having metadata in which at least one object and/or at least one user interaction included in the respective metadata matches at least one recognized object of the recognized one or more objects and at least one recognized user interaction of the recognized user interactions can be retrieved.

If a single stored data structure is retrieved, the recognized actions performed by the user, the recognized one or more objects, and the recognized one or more events in the environments are considered to correspond to the retrieved data structure. If multiple stored data structures are retrieved, a determination can be made to determine which retrieved data structure of the retrieved data structures that the recognized actions performed by the user, the recognized one or more objects, and the one or more recognized events in the environments most correspond to. In some embodiments, this determination can be made by counting a number of objects and user interactions included in the metadata for each retrieved data structure that match at least one recognized object of the recognized one or more objects and at least one recognized user interaction of the recognized user interactions and determining which retrieved data structure includes the greatest number of matching objects and user interactions included its metadata. In some embodiments, the determination can be made which retrieved data structure of the retrieved data structures the recognized actions performed by the user, the recognized one or more objects, and the recognized one or more events in the environments most correspond to using a similarity measure.

At block 906, one or more automations can be triggered in response to recognizing the routine. In some embodiments, in response to determining that the recognized actions performed by the user, the recognized one or more objects, and the recognized one or more events in the environments correspond to a stored data structure, one or more automations for the routine of the stored data structure can be triggered. In some embodiments, the one or more automations include presenting information associated with the routine on the display of the HMD. For example, if it is detected that the user is performing the routine described above with respect to FIG. 6, traffic information can be presented on the display of the HMD to assist the user during their commute. In some embodiments, the one or more automations include presenting other content to the user such as the extended reality content 225 described above with respect to FIG. 2A.

### Illustrative Device

FIG. 10 is an illustration of a portable electronic device 1000. The portable electronic device 1000 can be implemented in various configurations in order to provide a various functionality to a user. For example, the portable electronic device 1000 can be implemented as a wearable device (e.g., a head-mounted device, smart eyeglasses, smart watch, and/or smart clothing), a communication device (e.g., a smart, cellular, mobile, wireless, portable, and/or radio telephone), a home management device (e.g., a home automation controller, smart home controlling device, and smart appliances), a vehicular device (e.g., autonomous vehicle), and/or computing device (e.g., a tablet computer, a notebook computer, a laptop computer, and/or a personal digital assistant). The foregoing implementations are not intended to be limiting and the portable electronic device 1000 can be implemented as any kind of electronic or computing device that is configured to provide an extended reality system using a part of or all of the methods disclosed herein.

The portable electronic device 1000 includes processing system 1008, which includes one or more memories 1010, one or more processors 1012, and RAM 1014. The one or more processors 1012 can read one or more programs from the one or more memories 1010 and execute them using RAM 1014. The one or more processors 1012 can be of any type including but not limited to a microprocessor, a microcontroller, a graphical processing unit, a digital signal processor, an ASIC, a FPGA, or any combination thereof. In some embodiments, the one or more processors 1012 can include a plurality of cores, one or more coprocessors, and/or one or more layers of local cache memory. The one or more processors 1012 can execute the one or more programs stored in the one or more memories 1010 to perform operations as described herein including those described with respect to FIG. 1-9.

The one or more memories 1010 can be non-volatile and can include any type of memory device that retains stored information when powered off. Non-limiting examples of memory include electrically erasable and programmable read-only memory (EEPROM), flash memory, or any other type of non-volatile memory. At least one memory of the one or more memories 1010 can include a non-transitory computer-readable storage medium from which the one or more processors 1012 can read instructions. A computer-readable storage medium can include electronic, optical, magnetic, or other storage devices capable of providing the one or more processors 1012 with computer-readable instructions or other program code. Non-limiting examples of a computer-readable storage medium include magnetic disks, memory chips, read-only memory (ROM), RAM, an ASIC, a configured processor, optical storage, or any other medium from which a computer processor can read the instructions.

The portable electronic device 1000 also includes one or more storage devices 1018 configured to store data received by and/or generated by the portable electronic device 1000. The one or more storage devices 1018 can be removable storage devices, non-removable storage devices, or a combination thereof. Examples of removable storage and non-removable storage devices include magnetic disk devices such as flexible disk drives and HDDs, optical disk drives such as compact disk (CD) drives or digital versatile disk (DVD) drives, SSDs, and tape drives.

The portable electronic device 1000 can also include other components that provide additional functionality. For example, camera circuitry 1002 can be configured to capture images and video of a surrounding environment of the portable electronic device 1000. Examples of camera circuitry 1002 include digital or electronic cameras, light field cameras, 3D cameras, image sensors, imaging arrays, and the like. Similarly, audio circuitry 1022 can be configured to record sounds from a surrounding environment of the portable electronic device 1000 and output sounds to a user of the portable electronic device 1000. Examples of audio circuitry 1022 include microphones, speakers, and other audio/sound transducers for receiving and outputting audio signals and other sounds. Display circuitry 1006 can be configured to display images, video, and other content to a user of the portable electronic device 1000 and receive input from the user of the portable electronic device 1000. Examples of the display circuitry 1006 can include an LCD, a LED display, an OLED display, and a touchscreen display. Communications circuitry 1004 can be configured to enable the portable electronic device 1000 to communicate with various wired or wireless networks and other systems and devices. Examples of communications circuitry 1004 include wireless communication modules and chips, wired communication modules and chips, chips for communicating over local area networks, wide area networks, cellular networks, satellite networks, fiber optic networks, and the like, systems on chips, and other circuitry that enables the portable electronic device 1000 to send and receive data. Orientation detection circuitry 1020 can be configured to determine an orientation and a posture for the portable electronic device 1000 and/or a user of the portable electronic device 1000. Examples of orientation detection circuitry 1020 include GPS receivers, ultra-wideband (UWB) positioning devices, accelerometers, gyroscopes, motion sensors, tilt sensors, inclinometers, angular velocity sensors, gravity sensors, and inertial measurement units. Haptic circuitry 1026 can be configured to provide haptic feedback to and receive haptic feedback from a user of the portable electronic device 1000. Examples of haptic circuitry 1026 include vibrators, actuators, haptic feedback devices, and other devices that generate vibrations and provide other haptic feedback to a user of the portable electronic device 1000. Power circuitry 1024 can be configured to provide power to the portable electronic device 1000. Examples of power circuitry 1024 include batteries, power supplies, charging circuits, solar panels, and other devices configured to receive power from a source external to the portable electronic device 1000 and power the portable electronic device 1000 with the received power.

The portable electronic device 1000 can also include other I/O components. Examples of such input components can include a mouse, a keyboard, a trackball, a touch pad, a touchscreen display, a stylus, data gloves, and the like. Examples of such output components can include holographic displays, 3D displays, projectors, and the like.

### Additional Considerations

Although specific examples have been described, various modifications, alterations, alternative constructions, and equivalents are possible. Examples are not restricted to operation within certain specific data processing environments but are free to operate within a plurality of data processing environments. Additionally, although certain examples have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described examples may be used individually or jointly.

Further, while certain examples have been described using a particular combination of hardware and software, it should be recognized that other combinations of hardware and software are also possible. Certain examples may be implemented only in hardware, or only in software, or using combinations thereof. The various processes described herein may be implemented on the same processor or different processors in any combination.

Where devices, systems, components or modules are described as being configured to perform certain operations or functions, such configuration may be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes may communicate using a variety of techniques including but not limited to conventional techniques for inter-process communications, and different pairs of processes may use different techniques, or the same pair of processes may use different techniques at different times.

Specific details are given in this disclosure to provide a thorough understanding of the examples. However, examples may be practiced without these specific details. For example, well-known circuits, processes, algorithms, structures, and techniques have been shown without unnecessary detail in order to avoid obscuring the examples. This description provides example examples only, and is not intended to limit the scope, applicability, or configuration of other examples. Rather, the preceding description of the examples will provide those skilled in the art with an enabling description for implementing various examples. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific examples have been described, these are not intended to be limiting. Various modifications and equivalents are within the scope of the following claims.

In the foregoing specification, aspects of the disclosure are described with reference to specific examples thereof, but those skilled in the art will recognize that the disclosure is not limited thereto. Various features and aspects of the above-described disclosure may be used individually or jointly. Further, examples may be utilized in any number of environments and applications beyond those described herein without departing from the broader spirit and scope of the specification. The specification and drawings are, accordingly, to be regarded as illustrative rather than restrictive.

In the foregoing description, for the purposes of illustration, methods were described in a particular order. It should be appreciated that in alternate examples, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Where components are described as being configured to perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

While illustrative examples of the application have been described in detail herein, it is to be understood that the inventive concepts may be otherwise variously embodied and employed, and that the appended claims are intended to be construed to include such variations, except as limited by the prior art.

What is claimed is:

1. An extended reality system comprising:
a head-mounted device comprising a display that displays content to a user and one or more sensors that capture input comprising images of a visual field of the user wearing the head-mounted device;
one or more processors; and
one or more memories accessible to the one or more processors, the one or more memories storing a plurality of instructions executable by the one or more processors, the plurality of instructions comprising instructions that, when executed by the one or more processors, cause the one or more processors to perform processing comprising:
collecting, at least using the one or more cameras, first data corresponding to a routine performed by the user, the first data comprising information representing a plurality of interactions by the user with respect to a plurality of objects in a real-world environment, a virtual environment, or a combination thereof; and
learning the routine from the collected first data, wherein learning the routine from the collected first data comprises:
presenting a visual graph to the user;
defining a plurality of nodes in the visual graph based on input received from the user, wherein at least one node of the plurality of nodes associates at least one interaction of the plurality of interactions with at least one object of the plurality of objects;
specifying a relationship between a first node and a second node of the plurality of nodes in the visual graph;
arranging the plurality of nodes in the visual graph into a plurality of segments based on the relationship between the first node and the second node of the plurality of nodes; and
storing the visual graph in a data structure for the routine.

2. The extended reality system of claim 1, wherein the plurality of interactions comprises an interaction in which the user touches an object of the plurality of objects, an interaction in which an object of the plurality of objects appears in a view of the user, an interaction in which an object of the plurality of objects disappears from a view of the user, an interaction in which an object of the plurality of objects is present in a view of the user when the routine is performed by the user, or any combination thereof.

3. The extended reality system of claim 1, wherein the input received from the user includes a natural language statement made by the user, a gesture made by the user, a gaze of the user, or any combination thereof.

4. The extended reality system of claim 1, wherein at least one other node of the plurality of nodes associates the at least one object of the plurality of objects with at least one other object of the plurality of objects.

5. The extended reality system of claim 1, wherein the relationship between the first node and the second node of the plurality of nodes is a sequential relationship representing that an object corresponding to the first node occurs in a sequence before an object corresponding to the second node.

6. The extended reality system of claim 1, wherein the plurality of segments comprising a start segment that includes a node of the plurality of nodes representing a beginning of the routine and an end segment that includes a node of the plurality of nodes representing an ending of the routine.

7. The extended reality system of claim 1, the processing further comprising:
collecting, at least using the one or more sensors, second data comprising information representing a plurality of interactions by the user with respect to a plurality of objects in a real-world environment, a virtual environment, or a combination thereof;
recognizing a routine from the collected second data, the recognized routine corresponding the learned routine; and
triggering one or more automations in response to recognizing the routine.

8. A method comprising:
collecting, at least using one or more sensors of a head-mounted device, first data corresponding to a routine performed by a user, the first data comprising information representing a plurality of interactions by the user with respect to a plurality of objects in a real-world environment, a virtual environment, or a combination thereof; and
learning the routine from the collected first data, wherein learning the routine from the collected first data comprises:
presenting a visual graph to the user;
defining a plurality of nodes in the visual graph based on input received from the user, wherein at least one node of the plurality of nodes associates at least one interaction of the plurality of interactions with at least one object of the plurality of objects;
specifying a relationship between a first node and a second node of the plurality of nodes in the visual graph;
arranging the plurality of nodes in the visual graph into a plurality of segments based on the relationship between the first node and the second node of the plurality of nodes; and
storing the visual graph in a data structure for the routine.

9. The method of claim 8, wherein the plurality of interactions comprises an interaction in which the user touches an object of the plurality of objects, an interaction in which an object of the plurality of objects appears in a view of the user, an interaction in which an object of the plurality of objects disappears from a view of the user, an interaction in which an object of the plurality of objects is present in a view of the user when the routine is performed by the user, or any combination thereof.

10. The method of claim 8, wherein the input received from the user includes a natural language statement made by the user, a gesture made by the user, a gaze of the user, or any combination thereof.

11. The method of claim 8, wherein at least one other node of the plurality of nodes associates the at least one object of the plurality of objects with at least one other object of the plurality of objects.

12. The method of claim 8, wherein the relationship between the first node and the second node of the plurality of nodes is a sequential relationship representing that an object corresponding to the first node occurs in a sequence before an object corresponding to the second node.

13. The method of claim 8, wherein the plurality of segments comprising a start segment that includes a node of the plurality of nodes representing a beginning of the routine and an end segment that includes a node of the plurality of nodes representing an ending of the routine.

14. The method of claim 8, further comprising:
collecting, at least using the one or more sensors, second data comprising information representing a plurality of interactions by the user with respect to a plurality of objects in a real-world environment, a virtual environment, or a combination thereof;
recognizing a routine from the collected second data, the recognized routine corresponding the learned routine; and
triggering one or more automations in response to recognizing the routine.

15. One or more non-transitory computer-readable media storing computer-readable instructions that, when executed by one or more processing systems, cause the one or more processing systems to perform operations including:
collecting, at least using one or more sensors of a head-mounted device, first data corresponding to a routine performed by a user, the first data comprising information representing a plurality of interactions by the user with respect to a plurality of objects in a real-world environment, a virtual environment, or a combination thereof; and
learning the routine from the collected first data, wherein learning the routine from the collected first data comprises:
presenting a visual graph to the user;
defining a plurality of nodes in the visual graph based on input received from the user, wherein at least one node of the plurality of nodes associates at least one interaction of the plurality of interactions with at least one object of the plurality of objects;
specifying a relationship between a first node and a second node of the plurality of nodes in the visual graph;
arranging the plurality of nodes in the visual graph into a plurality of segments based on the relationship between the first node and the second node of the plurality of nodes; and
storing the visual graph in a data structure for the routine.

16. The one or more non-transitory computer-readable media of claim 15, wherein the plurality of interactions comprises an interaction in which the user touches an object of the plurality of objects, an interaction in which an object of the plurality of objects appears in a view of the user, an interaction in which an object of the plurality of objects disappears from a view of the user, an interaction in which an object of the plurality of objects is present in a view of the user when the routine is performed by the user, or any combination thereof.

17. The one or more non-transitory computer-readable media of claim 15, wherein at least one other node of the plurality of nodes associates the at least one object of the plurality of objects with at least one other object of the plurality of objects.

18. The one or more non-transitory computer-readable media of claim 15, wherein the relationship between the first node and the second node of the plurality of nodes is a sequential relationship representing that an object corresponding to the first node occurs in a sequence before an object corresponding to the second node.

19. The one or more non-transitory computer-readable media of claim 15, wherein the plurality of segments comprising a start segment that includes a node of the plurality of nodes representing a beginning of the routine and an end segment that includes a node of the plurality of nodes representing an ending of the routine.

20. The one or more non-transitory computer-readable media of claim 15, the operations further comprising:
collecting, at least using the one or more sensors, second data comprising information representing a plurality of interactions by the user with respect to a plurality of objects in a real-world environment, a virtual environment, or a combination thereof;
recognizing a routine from the collected second data, the recognized routine corresponding the learned routine; and
triggering one or more automations in response to recognizing the routine.
